(19) United States
(12) Patent Application Publication
(10) Pub. No.: US 2009/0087730 A1
(43) Pub. Date: Apr. 2, 2009

(54) Battery device and all-solid lithium-ion secondary battery

(75) Inventors: Shigeo Kondo, Hiyakata-city (JP); Yasumasa Takeuchi, Yokohama-city (JP); Yuji Shinohara, Kofu-shi (JP); Takeo Kawase, Suwa-shi (JP)

Correspondence Address: OLIFF & BERRIDGE, PLC, P.O. BOX 320850, ALEXANDRIA, VA, 22320-4850, US

(73) Assignee: SEIKO EPSON CORPORATION, Tokyo (JP)

(21) Appl. No.: 12/230,766

(22) Filed: Sep. 4, 2008

(30) Foreign Application Priority Data
Sep. 5, 2007 (JP) 2007-230852

(51) Int. Cl. H01M 2/28

(52) U.S. Cl. 429/161

(57) ABSTRACT

A battery device comprises a first lead board having one surface and the other surface, a second lead board having one surface and the other surface, the one surface of the second lead board facing the one surface of the first lead board through a spacing, a first terminal electrode formed on the one surface of the first lead board, a second terminal electrode formed on the one surface of the second lead board, and a solid electrolyte of conducting a lithium ion provided in the spacing between the one surface of the first lead board and the one surface of the second lead board so as to cover at least one of the first terminal electrode and the second terminal electrode. Such a battery device can eliminate occurrence of short-circuit between the cathode and the anode, which likely to occur during the production of an all-solid secondary battery. Further, an all-solid lithium-ion secondary battery provided with the battery device is also provided.

### CROSS-REFERENCE TO RELATED APPLICATION

This application claims a priority to Japanese Patent Application No. 2007-230852 filed on Sep. 5, 2007 which is hereby expressly incorporated by reference herein in its entirety.

### BACKGROUND

1. Technical Field

The present invention relates to a battery device and an all-solid lithium-ion secondary battery, more particularly, a battery device in which a solid electrolyte of conducting a lithium ion is provided between a pair of electrodes and an all-solid lithium-ion secondary battery provided with such a battery device.

2. Related Art

Along with development of portable equipment such as a personal computer and a cellular phone, demand for a small-sized lightweight battery as a power source of the portable equipment shows a drastic increase in recent years.

In particular, it is predicted that a lithium battery realizes a high energy density since lithium has a reduced atomic weight and increased ionization energy. Extensive research has been made in this respect, as a result of which the lithium battery is widely used as a power source of the portable equipment these days.

Expansion of a lithium battery market demands a lithium battery having a higher energy density. In order to comply with such a demand, internal energy of the lithium battery has been made greater by increasing the quantity of an active material contained in the battery.

Concomitant with this trend, a noticeable increase has been made in the quantity of organic solvent contained in an electrolyte (electrolytic solution) which is a flammable material filled in the battery. This results in an increased danger of battery firing and, therefore, the problem of battery safety becomes at issue in recent years.

One of highly effective methods for assuring the safety of a lithium battery is to replace an electrolyte containing organic solvent with a nonflammable solid electrolyte. Among others, use of an inorganic solid electrolyte of conducting a lithium ion makes it possible to develop an all-solid lithium battery that exhibits improved safety. Active research is now being made in this connection.

As an example, S. D. Jhones and J. R. Akridge, J. Power Sources, 43-44, 505 (1993) discloses an all-solid thin film lithium secondary battery produced by sequentially forming a cathode thin film, an electrolyte thin film and an anode thin film through the use of a deposition apparatus or a sputtering apparatus. It was reported that the thin film lithium secondary battery exhibits superior charge-discharge cycle characteristics of several thousand cycles or more.

With this thin film lithium secondary battery, however, it is impossible for a battery element to retain an electrode active material in a large quantity, thereby making it difficult to obtain a high capacity battery. In order to increase the battery capacity, a great quantity of electrode active materials should be contained in an electrode.

Further, an ion-conducting path and an electron-conducting path thereof should be ensured. Therefore, there is a need to construct a bulk type battery having a large battery capacity by using electrodes constituted of an electrode mixture material which includes a solid electrolyte and an electrode active material.

Generally, a bulk type battery is produced by placing an electrode material containing a cathode active material, a solid electrolyte and an electrode material containing an anode active material into a mold of a press machine, pressure-molding the electrode materials and the solid electrolyte by the press machine to obtain a battery device, and placing the battery device into a battery container of a coin type.

Such a bulk type battery includes a pair of electrodes (that is, cathode and anode) and an electrolyte layer provided between the electrodes. If shapes of the electrodes and the electrolyte layer, in particular areas of surfaces of the electrodes are the same as areas of surfaces of the electrolyte layer which are in contact with the surfaces of the electrodes, electron short circuit occurs between the cathode and the anode.

This is because a part of the cathode active material and the anode active material (electrode active material) is separated from the cathode and the anode to a peripheral surface of the electrolyte layer. Therefore, it is very difficult to produce a battery device which exhibits normal battery performance. In such a case, there is a need to remove the electrode active material existing in the peripheral surface of the electrolyte layer by sanding or grinding the peripheral surface.

In such a bulk type battery, if a large amount of the electrode active material is contained in the electrodes for the purpose of obtaining a large battery capacity, impedance increases in the electrodes due to the increased thickness thereof. Therefore, even if the large amount of the electrode active material is contained in electrodes, it is difficult to improve the battery capacity in proportion to the increased amount of the electrode active material. Rather, this results in a problem in that battery efficiency is lowered.

Therefore, the increased battery capacity is ensured by connecting a plurality of thin electrodes (formed of a small amount of the electrode active material) in parallel. The plurality of thin electrodes connected in parallel are housed into a battery pack to thereby obtain an assembled battery. However, too thin electrodes inhibit electron conductivity to the electrode active material contained therein. Therefore, it is difficult to obtain a battery capacity in proportion to the thickness (amount) thereof. This is also a problem in that battery efficiency is lowered.

In a general battery pack, namely a battery of a laminate type in which a plurality of electrodes are laminated and housed into a battery pack, there is a need to include each cell constituted from a pair of electrodes into an independent container due to a common electrolyte between the electrodes.

Therefore, a space in the battery container housing the plurality of electrodes is expanded in a thickness direction thereof depending on a number of the cells each including the pair of electrodes, and thereby a weight of the battery is increased. This is a problem in that this results in an increased size of electric equipment using the battery.

A volume of each electrode active material contained in electrodes of a battery device is changed in common according to discharge and charge thereof. Therefore, a thickness and a surface area of each electrode (cathode and anode) are expanded or contracted according to the change of the volume of the electrode active material.

In particular, in the case where an organic liquid electrolyte or a polymer electrolyte is used as an electrolyte, these electrolytes react easily with trace moisture contained in the electrolyte at a late stage of charge-discharge cycles (the electrode active materials also repeat a charge-discharge reaction).

In such a circumstance, gas is apt to generate inside the battery. In the worst case, disadvantages such as break of a battery pack, ignition of a battery, and adverse affect to peripheral devices of the battery occur. In the case where a metallic lithium alloy is used as an electrode active material, the metallic lithium alloy reacts reversibly.

In this case, a volume of the electrode active material is changed up to a few times in accordance with a charge-discharge reaction as compared to an initial volume thereof in a state that the battery has never been discharged and charged.

However, in the case where an interlayer compound is used as the electrode active material, such a change is a few percent and a change of the electrode active material in a thickness direction is not a problem. An adverse affect is given to battery performance by cutoff of an electron-connecting path between the electrode active materials contained in the electrodes, which is derived from expanding or contracting of areas of surfaces of electrodes, or inhibition of connection between the electrolyte layer and the electrodes.

Since all component materials of an all-solid secondary battery are solid, the all-solid secondary battery makes it possible to independently set battery devices (electrodes or cells) therein in the case where the battery is formed into a laminate type. Therefore, electrolyte layers contained in such independent cells are also independent to each other. As a result, a problem resulted from a common electrolyte can be eliminated between such independent cells, and therefore the all-solid secondary battery is advantageous in laminate.

In the all-solid secondary battery using such a solid electrolyte having no fluidity, the solid electrolyte can be fixed between the electrodes of each cell, and thereby enabling to eliminate the problem resulted from the common electrolyte. However, if sizes of the electrodes and the electrolyte layer are the same as to each other in the all-solid secondary battery, electrode active materials are separated from peripheral surfaces of the electrodes to a peripheral surface of the electrolyte layer during production of the all-solid secondary battery.

As a result, short-circuit easily occurs between the cathode and the anode due to the separated electrode active materials. For these reasons, in the secondary battery of the laminate type which is constituted from a plurality of cells (battery device), it is required to completely eliminate occurrence of such short-circuit.

### SUMMARY

Accordingly, it is a first object of the present invention to provide a battery device in which both ends of an electrolyte filled in a spacing between the cathode and the anode is not contaminated by a cathode active material and an anode active material separated from the cathode and the anode, respectively, which are likely to occur during production of the all-solid secondary battery, thereby completely eliminating occurrence of short-circuit between the cathode and the anode.

Further, it is a second object of the present invention to provide an assembled battery device including a battery device which can maintain performance of a charge-discharge capacity by itself. By connecting electrodes included in such a battery device in parallel, it is possible to suppress inside impedance thereof in a low level and proportionally increase a battery capacity.

It is also possible to obtain improved charge-discharge efficiency with current density in high output as compared to an electric cell including electrodes produced by using an electrode active material of which amount is the same as that of an electrode active material of electrodes included in the battery device of the present invention.

Furthermore, it is a third object of the present invention to provide a battery device of a laminate type which can maintain charge-discharge performance by itself, avoid a total thickness of the produced battery device from being increased, and improve volume efficiency thereof.

Furthermore, it is a fourth object of the present invention to provide an all-solid lithium-ion secondary battery which is provided with the battery device as described above.

These objects are achieved by the present invention described below.

In a first aspect of the present invention, there is provided a battery device. The battery device comprises a first lead board having one surface and the other surface, a second lead board having one surface and the other surface, the one surface of the second lead board facing the one surface of the first lead board through a spacing, a first terminal electrode formed on the one surface of the first lead board, a second terminal electrode formed on the one surface of the second lead board, and a solid electrolyte of conducting a lithium ion provided in the spacing between the one surface of the first lead board and the one surface of the second lead board so as to cover at least one of the first terminal electrode and the second terminal electrode.

According to the battery device described above, it is possible to easily prevent short-circuit between the first terminal electrode and the second terminal electrode from occurring by separation of an electrode active material from both the first terminal electrode and the second terminal electrode, which is apt to generate during production of all-solid lithium-ion secondary battery of a bulk type.

In the battery device according to the present invention, it is preferred that the first terminal electrode is cathode and the second terminal electrode is anode.

In the battery device according to the present invention, it is also preferred that a thickness of each of the first terminal electrode and the second terminal electrode is in the range of 50 to 500 μm.

This makes it possible to provide an all-solid lithium-ion secondary battery which is capable of exhibiting superior charge-discharge performance of the battery device.

In the battery device according to the present invention, it is also preferred that the battery device further comprises one or more intermediate electrodes provided in the spacing so as to be parallel with both the first terminal electrode and the second terminal electrode wherein the first terminal electrode, the second terminal electrode and the one or more intermediate electrodes are connected in series or parallel.

By changing a number of laminated electrodes in the battery device, it is possible to obtain a predetermined voltage and battery capacity. Further, it is possible to connect electrodes of the battery device included in a battery container with a simple connecting structure.

In the battery device according to the present invention, it is also preferred that each of the first terminal electrode and the second terminal electrode includes a collector having a mesh structure with irregularities.

Such a collector makes it possible to reliably exhibit functions thereof due to the mesh structure, and therefore it is possible to suppress formation or generation of gaps (spaces) between the electrolyte and the first terminal electrode or the second terminal electrode.

In particular, it is possible to reliably prevent formation or generation of the gaps (spaces) between the electrolyte and the first terminal electrode or the second terminal electrode due to repeated charge-discharge cycles. Additionally, it is also possible to uniformize a current density in the first terminal electrode and second terminal electrode.

In the battery device according to the present invention, it is also preferred that each of the one or more intermediate electrodes includes at least a collector wherein in the case where the first terminal electrode, the second terminal electrode and the one or more intermediate electrodes are connected in series, each collector is formed from a conductive substrate having a mesh structure.

This makes it possible to produce a battery of a laminate type having a smaller total thickness.

In the battery device according to the present invention, it is also preferred that the solid electrolyte is constituted of a sulfide-based lithium-ion conductor.

In the battery device according to the present invention, it is also preferred that the sulfide-based lithium-ion conductor is an amorphous material, a crystalline material or a mixture of the amorphous material and the crystalline material.

This makes it possible to obtain an all-solid lithium-ion secondary battery having a low inside impedance due to use of such a sulfide-based lithium-ion conductor. Further, use of the sulfide-based lithium-ion conductor (e.g. thio-silicone) constituted of the crystalline material also makes it possible to provide superior electrode molding and improve interface bonding between the electrodes and the electrolyte. Therefore, there is an advantage in that the produced all-solid lithium-ion secondary battery can generate large output current.

Furthermore, use of the sulfide-based lithium-ion conductor constituted of the amorphous material, in which current flows in a state of no anisotropy, exhibits the following advantages. That is, use of such a sulfide-based lithium-ion conductor can exhibit superior preservation performance of the all-solid lithium-ion secondary battery due to superior thermal stability of the amorphous material. Further, use of such a sulfide-based lithium-ion conductor can obtain small distribution of a current density in the electrodes in contacting with the electrolyte using the amorphous material.

Furthermore, use of the mixture of the amorphous material and the crystalline material can expect a synergetic effect of the effects derived from the use of the both materials as described above.

In a second aspect of the present invention, there is provided an all-solid lithium-ion secondary battery provided with the battery device described above.

This makes it possible to obtain an all-solid lithium-ion secondary battery in which occurrence of short-circuit is eliminated.

### BRIEF DESCRIPTION OF THE DRAWINGS

FIG. 1 is a vertical section view which shows an all-solid lithium-ion secondary battery in accordance with a first embodiment of the present invention.

FIG. 2 is a vertical section view which shows an all-solid lithium-ion secondary battery of a parallel laminate type in accordance with the present invention. This all-solid lithium-ion secondary battery includes an intermediate electrode.

FIG. 3 is a vertical section view which shows another all-solid lithium-ion secondary battery of a parallel laminate type in accordance with the present invention. An intermediate electrode included in the all-solid lithium-ion secondary battery is different from that of the all-solid lithium-ion secondary battery shown in FIG. 2

FIG. 4 is a vertical section view which shows an all-solid lithium-ion secondary battery of a series laminate type in accordance with the present invention.

FIGS. 5-1 and 5-2 are vertical section views which show terminal electrodes used in a battery device in accordance with the present invention. FIGS. 5-3 to 5-6 are vertical section views which show intermediate electrodes used in a battery device of a laminate type in accordance with the present invention.

FIG. 6 is a flowchart illustrating a method of producing an all-solid lithium-ion secondary battery in accordance with the present invention.

FIG. 7 is a vertical section view which shows a mold for producing a battery device.

FIG. 8 is a vertical section view which shows structures of various collectors with lead boards that can be used for producing an all-solid lithium-ion secondary battery.

FIG. 9 is a vertical section view which shows a battery device produced by a conventional method.

FIG. 10 is a vertical section view which shows a battery device produced by a method in accordance with the present invention.

FIG. 11 is a vertical section view which shows a battery device produced by a method in accordance with the present invention. The battery device is provided with a restrictor.

FIG. 12 is a vertical section view which shows a mold that can be used for producing a battery device in accordance with the present invention.

FIG. 13 is a flowchart illustrating a method of producing a battery device in accordance with the present invention.

FIGS. 14-1 to 14-3 are vertical section views which show molds that can be used for producing a battery device and an intermediate electrode used in the battery device in accordance with the present invention.

FIG. 15 is a vertical section view which shows an all-solid lithium secondary battery produced by a conventional method.

FIG. 16 is a vertical section view which shows an all-solid lithium-ion secondary battery produced by a method of the present invention.

FIGS. 17-A and 17-B are vertical section views which show battery devices of a laminate type produced by a method of the present invention, wherein FIG. 17-A shows a battery device of a series laminate type, and FIG. 17-B shows a battery device of a parallel laminate type.

FIG. 18 is vertical section views which show all-solid lithium-ion secondary batteries of parallel and series laminate types produced by a method of the present invention.

FIG. 19 is a graph which shows a relation between a thickness of an electrode and a discharge capacity of a battery in the all-solid lithium-ion secondary battery in accordance with the present invention.

### DESCRIPTION OF EXEMPLARY EMBODIMENTS

Hereinbelow, a battery device and an all-solid lithium-ion secondary battery according to the present invention will be described in detail with reference to preferred embodiments shown in the accompanying drawings.

### First Embodiment

First, a first embodiment of a battery device and an all-solid lithium-ion secondary battery according to the present invention will be described in detail.

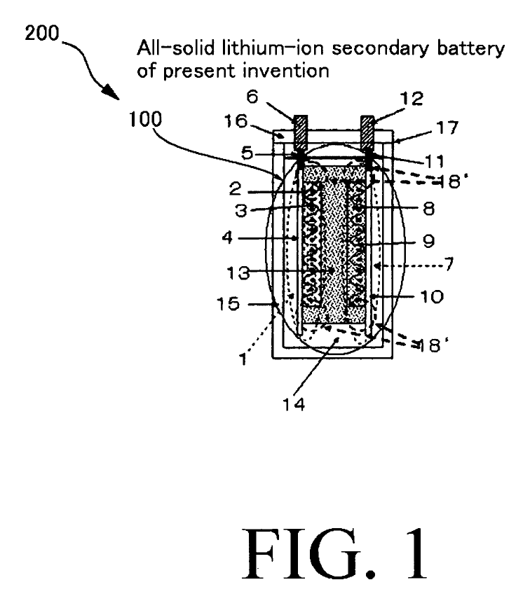

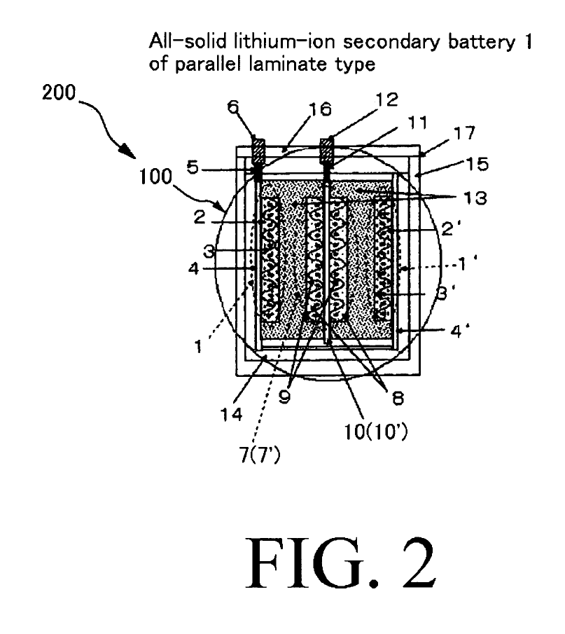

FIG. 1 is a vertical section view which shows an all-solid lithium-ion secondary battery in accordance with a first embodiment of the present invention. FIG. 2 is a vertical section view which shows an all-solid lithium-ion secondary battery of a parallel laminate type in accordance with the present invention. The all-solid lithium-ion secondary battery shown in FIG. 2 includes an intermediate electrode.

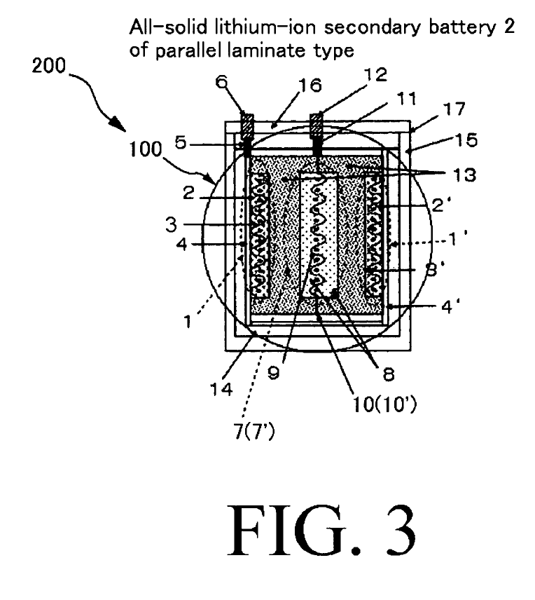

FIG. 3 is a vertical section view which shows another all-solid lithium-ion secondary battery of a parallel laminate type in accordance with the present invention. An intermediate electrode included in the all-solid lithium-ion secondary battery is different from that of the all-solid lithium-ion secondary battery shown in FIG. 2

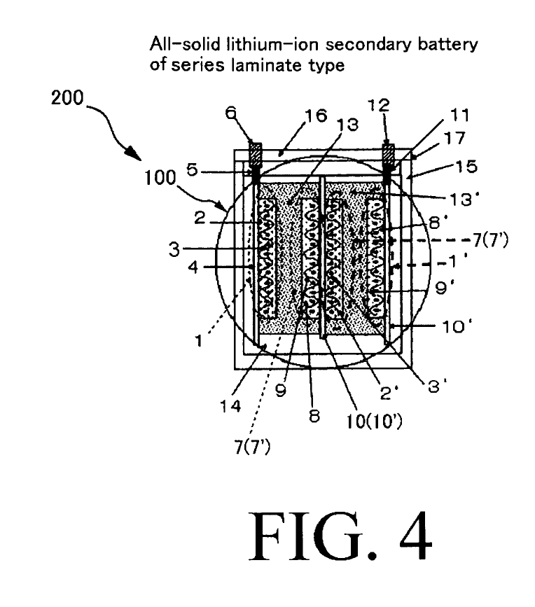

FIG. 4 is a vertical section view which shows an all-solid lithium-ion secondary battery of a series laminate type in accordance with the present invention.

An all-solid lithium-ion secondary battery shown in FIG. 1 includes a battery container 15, a battery device 100 placed in the battery container 15 and an upper lid 16 for sealing the inside of the battery container 15 which is provided on the battery container 15.

The battery device 100 includes a cathode lead board 4, an anode lead board 10 facing the cathode lead board 4, a cathode 1 formed on the surface of the cathode lead board 4, an anode 7 formed on the surface of the anode lead board 10, and a solid electrolyte 13 of conducting a lithium ion (hereinafter, simply referred to as “electrolyte 13”) provided in a spacing defined between the surface of the cathode lead board 4 and the surface of the anode lead board 10.

Further, the electrolyte 13 is provided in contact with both surfaces of the cathode lead board 4 and the anode lead board 10 so as to cover both the cathode 1 and the anode 7. Additionally, the electrolyte 13 does not run out of areas of the both surfaces of the cathode lead board 4 and the anode lead board 10 in the spacing.

Further, the all-solid lithium-ion secondary battery also includes a fixed portion 14 provided in the battery container 15 so as to cover the whole battery device 100, a cathode end terminal 6 and an anode end terminal 12 which are provided on the upper lid 16, a cathode connection lead 5 connected between the cathode end terminal 6 and the cathode lead board 4, and an anode connection lead 11 connected between the anode end terminal 12 and the anode lead board 10.

Hereinbelow, description will be made with regard to the battery device 100 having the cathode 1, the anode 7 and the electrolyte 13. Seeing that the cathode 3 and the anode 7 have the same configuration in the present embodiment, the description will be made with regard to the cathode 3, as a representative.

The cathode 1 is formed from a collector 3 and an electrode (cathode) mixture material 2 filled in or coated on the collector 3. The cathode mixture material 2 is constituted of a mixture obtained by mixing an electrode (cathode) active material, a solid electrolyte material (powder), if needed, and a conductive agent such as a carbon as an electrode material. The collector 3 is formed from a mesh member, such as a conductive mesh member having through holes.

For the purpose of obtaining low internal resistance of the cathode 1 and equalization of current flowing in the cathode 1, the collector 3 has functions of providing electronic conductivity as well as reinforcement effect to an expansion or contraction phenomenon of the electrodes which may occur during charge and discharge of the electrodes. Therefore, it is preferred that the cathode 1 is fixed to the cathode lead board 4 and is connected thereto electrically.

Examples of a constituent material that can be used as the collector 3 and the cathode lead board 4 include: an electron-conducting metallic material such as copper (Cu), nickel (Ni), titanium (Ti) and stainless steel (SUS); and an insulating material such as a hard resin material which includes polycarbonate and ceramics which includes alumina and glass. In the case where the insulating material is used in the collector 3 or the cathode lead board 4, it is preferred that a conductive thin film is formed on the surface of the collector 3 or the cathode lead board 4.

In the case where the mesh member is used as the collector 3, the occupation percentage of the through-holes of the collector 3 in a plan view is preferably in the range of about 25 to 90% and more preferably in the range of about 70 to 85%, although it may slightly vary depending on the constituent material thereof and intended use of the collector 3.

Further, the collector 3 has an average thickness of preferably about 10 to 400 μm and more preferably about 50 to 300 μm.

In the cathode 1 of the present embodiment, the cathode mixture material 2 is filled into the mesh structure of the collector 3 so as to cover the entire surface of the collector 3. A thickness of the cathode lead board 4 is in the range of about 300 to 500 μm.

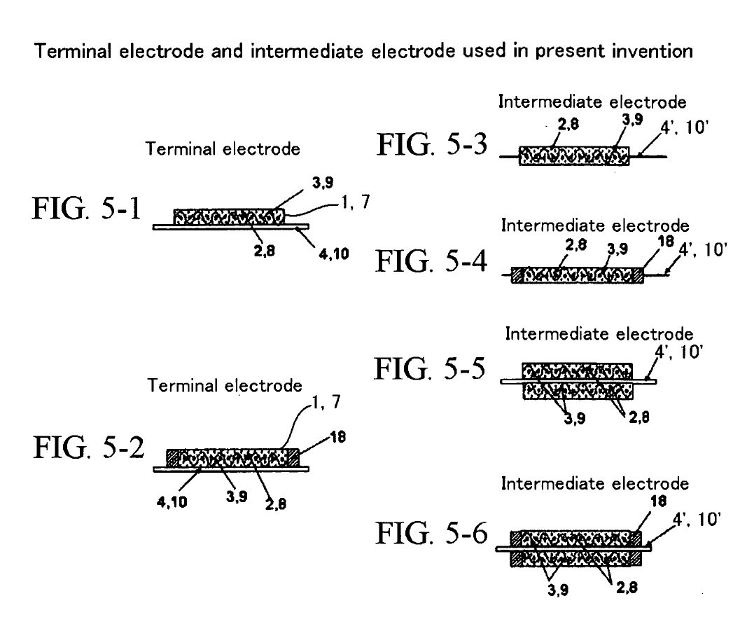

In a battery device 100 of a laminate type (FIGS. 2 to 4) including an intermediate electrode 7′ shown in FIGS. 5-3 and 5-5, a thickness of a lead board 10′ used in the intermediate electrode 7′ is preferably 100 μm or less and more preferably in the range of 30 to 50 μm.

As the cathode mixture material 2, an cathode active material or a mixture of the cathode active material and a solid electrolyte material (an electrode mixture material) may be used. If needed, the mixture may be further mixed with a conductive agent such as carbon.

By using the mixture of the cathode active material and the solid electrolyte material as the cathode mixture material 2, it becomes possible to increase the ion-conducting bonding interface between particles of the cathode active material and particles of the solid electrolyte material which constitute the cathode 1 (electrode), and also to increase the interface bonding force (adhesion) between the cathode 1 and the electrolyte 13.

This ensures that ions are smoothly transferred between each of the electrodes (1, 7) and the electrolyte 13, which makes it possible to improve the characteristics (charge-discharge characteristics) of the all-solid lithium-ion secondary battery 200.

Examples of the cathode active material that can be used in the present invention include: a transition metal oxide material such as lithium cobaltate (LiₓCoO₂), lithium nickelate (LiₓNiO₂), lithium nickel cobaltate (LiCo_{0.3}Ni_{0.7}O₂), lithium manganate (LiMn₂O₄), lithium titanate (Li_{4/3}Ti_{5/3}O₄), lithium manganate compound (LiM_{y}Mn_{2-y}O₄, where the M is Cr, Co or Ni), lithium iron phosphate and olivine compound, which is one kind of lithium iron phosphate compound (Li₁₋ₓFePO₄ and Li₁₋ₓFe_{0.5}Mn_{0.5}PO₄); sulfide-based chalcogen compound such as TiS₂, VS₂, FeS and M.MoS₈ (where the M is a transition metal such as Li, Ti, Cu, Sb, Sn, Pb and Ni); and a lithium metal oxide containing a metal oxide as its skeleton, such as TiO₂, Cr₃O₈, V₂O₅, MnO₂ and CoO₂.

On the other hand, examples of an anode active material include: a metallic material such as lithium, indium, aluminum; an alloy produced from these metallic materials and lithium; and the like. These materials may be used singly or in combination of one or more of them.

In the case of using the mixture of the cathode active material and the solid electrolyte material, the solid electrolyte material may either be the same kind as (identical to) or differ from a constituent material of the electrolyte 13 (electrolyte material) set forth below.

However, it is preferred that the solid electrolyte material is the same kind as (especially, identical to) the constituent material of the electrolyte 13. This assures smooth transfer of metal ions between the cathode 1 (electrode) and the electrolyte 13 and also helps to improve adhesion between them.

In this case, a mixing ratio of the cathode active material and the solid electrolyte material is preferably in the range of about 4:6 to 9:1 by weight and more preferably in the rage of about 5:5 to 8:2 by weight, although the mixing ratio is not particularly limited thereto.

As the cathode active material, it is desirable to use a granular (powdery) material having a particle size of 20 micron or less. Use of such a granular material makes it possible to fill the cathode mixture material 2 in the through-holes of the collector 3 in an easy and reliable manner.

An average thickness of the cathode 1 is in the range of 30 to 500 μm, more preferably in the range of 50 to 500 μm, and even more preferably in the range of 50 to 300 μm. If the average thickness of the cathode 1 is smaller than 30 μm, network paths in which electrons conduct to the cathode active material contained in the cathode 1 are reduced, thereby reducing output current.

If the average thickness of the cathode 1 is larger than 500 μm, ion-conducting paths from the cathode 1 to the electrolyte 13 through an interface between the electrolyte 13 and the cathode 1 become long. As a result, internal resistance of the cathode 1 becomes large whereas output current from a battery becomes small. Therefore, in order to obtain high charge-discharge performance of the all-solid lithium-ion secondary battery, the optimal thickness of the cathode 1 should lie within the range described above.

It is to be noted that the above descriptions of the cathode 1, the cathode lead board 7, the collector 3, the cathode active material and the cathode mixture material 2 can be applied to the anode 7, the anode lead board 10, an collector 9, the anode active material and an anode mixture material 8 in the present embodiment, respectively.

Next, description will be made with regard to other configuration examples of the cathode 1 with the cathode lead board 4 and the anode 7 with the anode lead board 10, namely terminal electrodes and an intermediate electrode. Hereinafter, it is to be noted that an electrode active material includes the cathode active material and the anode active material and an electrode mixture material includes the cathode mixture material 2 and the anode mixture material 8.

Electrodes shown in FIG. 5-1 and FIG. 5-2 are terminal electrodes of the battery device 100. These terminal electrodes are applied to the cathode 1 and the anode 7. In FIG. 5-1 and FIG. 5-2, the cathode active material 2 is filled into the collector 3 and the anode active material 8 is filled into the collector 9.

The collector 3 is connected with the cathode lead board 4 electrically and the collector 9 is connected with the anode lead board 10 electrically. A mesh member having electron conducting property may be used as the collectors 3 and 9.

Alternatively, instead of the mesh member used in each of the collectors 3, 9, a plate member having electron conductive property and having a surface formed with irregularities may be used. Such irregularities may be formed by a pressure-molding process or an etching process. By using such a plate member, it is possible to integrally form the collectors 3, 9 on the cathode lead board 4 and the anode lead board 10, respectively.

In FIG. 5-2, a restrictor 18 is formed on the cathode lead board 4 (the anode lead board 10) so as to surround the cathode 1 (anode 7). The restrictor 18 serves as a reinforcing body. An insulating material or a conducting material can be used as a constituent material of the restrictor 18.

Each of electrodes shown in FIG. 5-3 to FIG. 5-6 is an intermediate electrode (“7 (7′)” used in FIGS. 2 to 4) which is arranged between terminal electrodes (cathodes 1 and 1′ shown in FIGS. 2 to 4) included in a secondary battery of a laminate type produced by using the battery device 100.

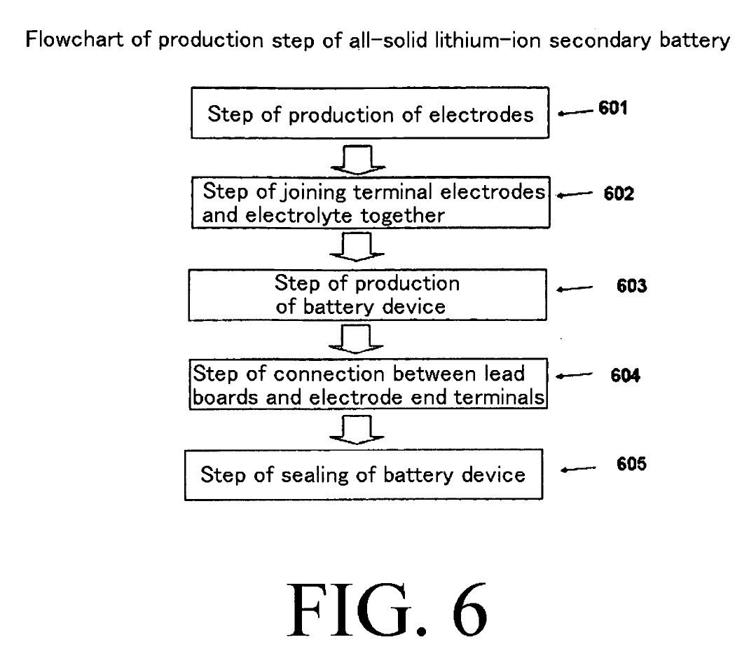

In the case where a secondary battery of a parallel laminate type is produced, any one of the intermediate electrodes shown in FIG. 5-3 to FIG. 5-6 can be selected. On the other hand, in the case where a secondary battery of a series laminate type is produced, any one of the intermediate electrodes shown in FIG. 5-5 and FIG. 5-6 can be selected.

In FIG. 5-3 and FIG. 5-4, the cathode mixture material 2 (anode mixture material 8) is formed on the both surfaces of the collector 3 (9) and filled into the collector 3 (9) so that thicknesses of the cathode mixture materials 2 (anode mixture material 8) formed on the both surfaces of the collector 3 become the same as to each other. The collector 3 (9) is electrically connected with the cathode lead board 4 (anode lead board 10).

In FIG. 5-4 and FIG. 5-6, a restrictor 18 is provided in a peripheral end portion of each of the electrodes so as to surround the electrode. The restrictor 18 serves as a reinforcing body. An insulating material or a conducting material can be used as a constituent material of the restrictor 18.

In FIG. 5-5 and FIG. 5-6, each of the intermediate electrodes is produced by forming the electrode on the both surfaces of the lead board 4′ (10′) with the lead board 4′ (10′) being placed at a center thereof. Constituent materials of the electrodes shown in FIG. 5-5 and FIG. 5-6 are the same as those shown in FIG. 5-3 and FIG. 5-4.

However, one point that the intermediate electrodes shown in FIG. 5-5 and FIG. 5-6 are different from the intermediate electrodes shown in FIG. 5-3 and FIG. 5-4 is that the electrodes are formed on the both surfaces of the lead board 4′ or the lead board 10′. Due to this structural difference, it is possible to prevent ions from flowing from one terminal electrode to the other terminal electrode included in the battery device 100 through the electrolyte 13. Such intermediate electrodes shown in FIG. 5-5 and FIG. 5-6 can be used in a secondary battery of a series laminate type.

In the terminal electrodes shown in FIG. 5-1 and FIG. 5-2 and the intermediate electrodes shown in FIG. 5-3 to FIG. 5-6, constituent materials of the electrodes used thereto may be identical or may be different from the constituent materials of the anode 1 and the cathode 7.

According to the present invention, the electrolyte 13 may be filled into the spacing provided between the cathode 1 and the anode 7 so as to cover at least one of the cathode 1 and the anode 7.

According to the present invention, the electrolyte 13 is filled into the spacing by pressure-molding solid electrolyte powder (solid electrolyte particles or solid electrolyte material). The solid electrolyte powder of conducting a lithium ion alone or a mixture of the solid electrolyte powder and insulating particles (materials) may be suitably used as the solid electrolyte powder.

An average particle size of the solid electrolyte particles is not particularly limited but is preferably in the range of about 1 to 20 μm and more preferably in the range of about 1 to 10 μm. Use of the solid electrolyte particles having such an average particle size makes it possible to improve the mutual contact of the solid electrolyte particles in the electrolyte 13, and also to increase the bonding area between the electrode active material (particles of the electrode active material) and the solid electrolyte particles in the electrodes.

Consequently, it becomes possible to sufficiently secure transfer paths of the lithium ion, thereby further improving the characteristics of the battery device 100 and a secondary battery of a laminate type produced by using the battery device 100.

Moreover, a distance between the terminal electrodes, namely an average thickness of the electrolyte 13 filled into the spacing is preferably in the range of about 10 to 500 μm and more preferably in the range of about 30 to 300 μm.

According to the present embodiment described above, the battery device 100 is constituted in a state that the electrolyte 13 covers both the cathode 1 and the anode 7. This makes it possible to prevent a peripheral end portion of the electrolyte 13 from being contaminated by the electrode active material and the conductive material separated from the electrodes which are formed by using the electrode mixture material obtained by mixing the electrode active material and the conductive material such as carbon. That is, it is possible to completely a phenomenon that short-circuit occurs between electrodes (the cathode 1 and the anode 7).

In general, in the case where the thickness of the electrolyte 13 included in the battery device 100 is made to be small, short-circuit is likely to occur between the electrodes by the electrode active material separated from the electrodes. As a result, in the battery of the laminate type formed from a plurality of thin electrodes and electrolyte, if only a defective electrode is included in such a battery of the laminate type, the battery can not exhibit its performance appropriately.

However, according to the battery device 100 of the present invention, since both the cathode 1 and the anode 7 are covered with the electrolyte 13, no short-circuit occurs in the battery device 100. In this way, the battery device 100 of the present invention exhibits superior effects as described above.

The surfaces of the cathode lead board 4 and the anode lead board 10 used in the present embodiment, namely the surfaces thereof in contact with the cathode 1 and the anode 7 may be formed with irregularities. By using such a cathode lead board 4 and an anode lead board 10, the irregular surfaces of the cathode lead board 4 and the anode lead board 10 can exhibit a function of the collector 3 and the collector 9, respectively. This makes it possible to obtain an advantage in that use of mesh members as the collectors 3 and 9 contained in the cathode 1 and the anode 7 can be omitted, respectively.

The irregular surfaces have concave portions and convex portions. The cross-section shape of the concave portions and the convex portions in such irregular surfaces is not limited particularly but may be: circular; ellipse; triangle; quadrangle such as rectangle, square and rhombus; polygon such as pentagon, hexagon and octagon; amorphous; or the like.

Further, two or more of the concave portions and the convex portions of which cross-section shapes are different from each other may be existed on the irregular surfaces of the cathode lead board 4 and the anode lead board 10.

A occupation percentage of an area of the concave portions in each of the irregular surfaces of the cathode lead board 4 and the anode lead board 10 is preferably in the range of about 25 to 90% and more preferably in the range of about 50 to 85% in a plan view.

Further, an average height of the convex portions is preferably in the range of about 50 to 400 μm and more preferably in the range of about 100 to 200 μm.

By setting the occupation percentage of the area of the concave portions and the average height of the convex portions within the above noted ranges, it is possible to reliably exhibit a function of a collector by the concave portions and the convex portions.

In order to discharge and charge the battery device 100, the cathode lead board 4 and the anode lead board 10 are connected to a cathode end terminal 6 and an anode end terminal 12 through the cathode connection lead 5 and the anode connection lead 11, respectively. In the battery device 100, the cathode connection lead 5 and the anode connection lead 11 are configured so that they pass through the fixed portion 14.

As shown in FIG. 1, since the battery device 100 is covered by the fixed portion 14 in the battery container 15, the fixed portion 14 is in contact with the peripheral end portion of the electrolyte 13 filled into the spacing. Further, as shown in FIGS. 5-2, FIG. 8 and FIG. 11, the restrictors 18 are formed on the cathode lead board 4 and the anode lead board 10 so as to surround the cathode 1 and the anode 7. Therefore, the restrictors 18 are also in contact with the electrolyte 13. In FIG. 1, portions 18′ in which the side surfaces of the cathode 1 and the anode 7 are in contact with the electrolyte 13 serve as the restrictor 18.

The restrictor 18 and the portions 18′ have a function of restricting (suppressing) expansion and contraction in a plane direction during the discharge and charge of the all-solid lithium-ion secondary battery 200 including the battery device 100. That is to say, the restrictor 18 and the portions 18′ have a function of restricting the expansion of the electrodes (cathode 1 and anode 7) in a plane direction (which is a direction perpendicular to a direction from the cathode 1 to the anode 7).

Further, the restrictor 18 and the portions 18′ also have a function of restricting expansion of a portion of the electrolyte 13 provided between the cathode 1 and anode 7 in the plane direction, which occurs in accordance with the expansion of the electrodes. As a result, the restrictor 18 and the portions 18′ can suppress disconnection or breakage of an electronic bond between the electrolyte 13 and the electrodes 1 and 7.

Generally, in the battery device 100, a crystal structure of the electrode active material is three-dimensionally deformed (expanded or contracted) in response to the charge-discharge operations.

Therefore, in a conventional all-solid lithium-ion secondary battery in which no restrictor is formed on a cathode lead board and a anode lead board, a crystal structure of an electrode active material is three-dimensionally deformed (changed) during the charge-discharge operations of the conventional all-solid lithium-ion secondary battery. Therefore, a cathode and an anode thereof are significantly deformed (expanded or contracted) not only in a thickness direction thereof but also in a plane direction thereof.

As a result, an electrolyte layer provided between the cathode and the anode is also expanded (or is contracted during the reverse reaction) in the plane direction. At that time, peripheral end portions of the cathode and the anode on which no electrolyte layer is provided are produced. This induces the deformation of the electrolyte layer in the plane direction.

In such peripheral end portions, since an electronic bond or an ion-conducting path between the electrolyte layer and the electrodes (electrode active material) is disconnected due to the deformation of the electrolyte layer, it becomes difficult for an current to flow between the electrodes in accordance with the repeated charge and discharge operations. As a result, in the peripheral end portions, separation between the electrodes (electrode active material) and the electrolyte layer occurs.

This phenomenon proceeds gradually as the conventional all-solid lithium-ion secondary battery is repeatedly charged and discharged. As a consequence, a battery capacity of the conventional all-solid lithium-ion secondary battery is gradually reduced, which makes it difficult to charge and discharge the conventional all-solid lithium-ion secondary battery.

In contrast, the battery device 100 of the present invention is configured to have the restrictor 8 that serves to restrict expansion of the cathode 1 and the anode 7 (electrode) in the plane direction thereof (the vertical direction in FIG. 1) and the resultant expansion of the electrolyte 13 in a plane direction thereof. Thus, the battery device 100 can be kept in a shape as close to the initial shape as possible when manufacturing the all-solid lithium-ion secondary battery 200 and charging and discharging the same.

That is to say, the afore-mentioned problem in the conventional all-solid lithium-ion secondary battery can be avoided by restricting expansion of the cathode (electrode) 1 and the electrolyte 13 in the plane direction thereof. As a result, it becomes possible to avoid battery capacity reduction which would otherwise occur over the lapse of charge-discharge cycles (by the multiple times of charge-discharge operations).

The constituent material of the restrictor 18 is not particularly limited, but preferably it is made of an insulating material, an electrical conductive material and an inactive material which does not affect a battery reaction. This makes it possible to reliably prevent occurrence of short-circuit between the cathode 1 and the anode 7.

Examples of the insulating material include: various kinds of resin materials such as a thermoplastic resin, a thermosetting resin and a photocurable resin; various kinds of glass materials such as low-melting-point glass; various kinds of ceramics materials; and the like.

Among these materials, it is preferable that the insulating material is any one of the thermoplastic resin, the thermosetting resin, the photocurable resin and the low-melting-point glass or a combination of two or more of them. Use of these materials allows the restrictor 18 to be formed with ease. Furthermore, use of these materials makes it possible to increase mechanical strength of the restrictor 8.

Examples of the thermoplastic resin include polyolefin, an ethylene-vinyl acetate copolymer, polyamide, polyamide and a hot-melt resin. Examples of the thermosetting resin include an epoxy-based resin, a polyurethane-based resin and a phenol-based resin.

Further, examples of the photocurable resin include an epoxy-based resin, an urethane acrylate-based resin and a vinyl ether-based resin. Examples of the low-melting-point glass include a P₂O₅—CuO—ZnO-based low-melting-point glass, a P₂O₅—SnO-based low-melting-point glass and a B₂O₃—ZnO—Bi₂O₃—Al₂O₃-based low-melting-point glass.

An average thickness of the restrictor 18 (particularly, the average thickness of a side surface thereof) is preferably in the range of about 30 to 500 μm and more preferably in the range of about 50 to 300 μm, although it may be slightly changed depending on a constituent material and intended use of the restrictor 18.

By setting the average thickness within the above noted range, it is possible to reliably prevent expansion of the cathode (electrode) 1 and the electrolyte 13 in the plane direction thereof, thereby allowing the restrictor 18 to play its role in a reliable manner.

Production of the conventional battery device (all-solid lithium-ion secondary battery) using the materials as described above is carried out as follows.

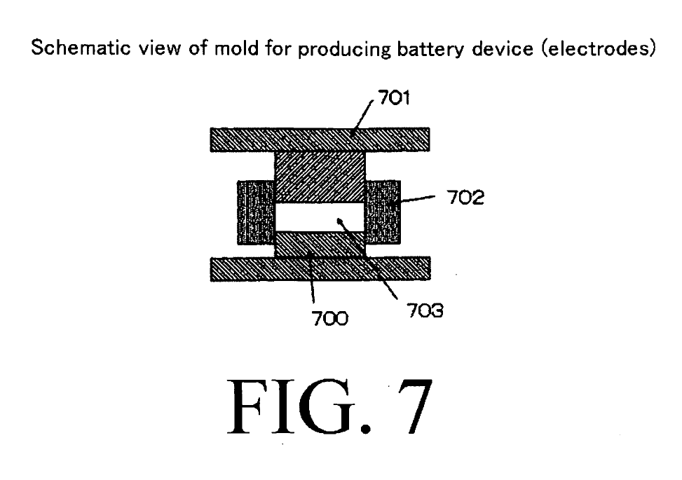

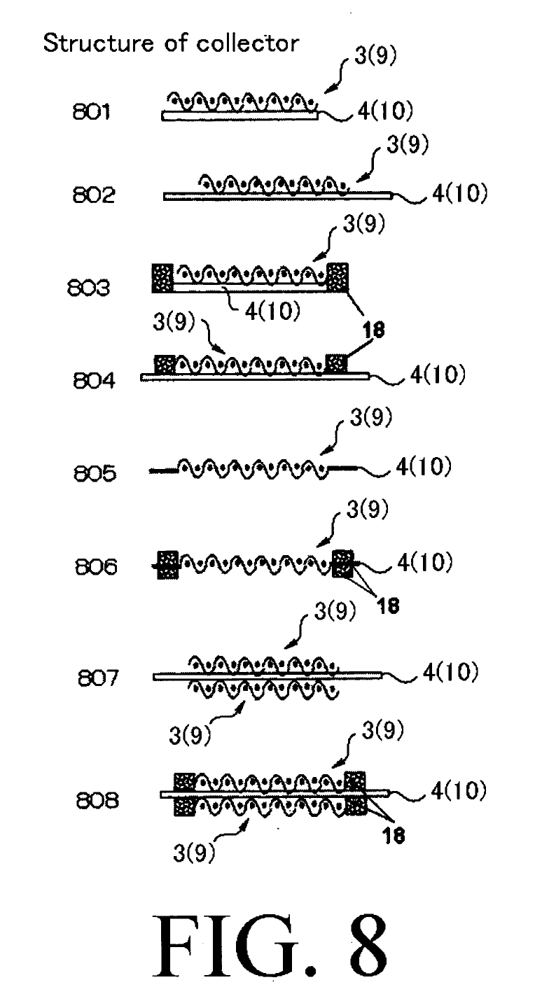

For example, a battery device is produced by using a mold as shown in FIG. 7. In a state that a lower male mold 700 is inserted into a cylindrical hole 703 of a female mold 702, a collector with a lead board 801 as shown in FIG. 8 is set so that the lead board thereof is in contact with the lower male mold 700.

Then, an electrode mixture material (cathode mixture material) is filled in the cylindrical hole 703 to obtain a layer of the electrode mixture material. After the surface of the layer is flatted, an upper male mold 701 is inserted into the cylindrical hole 703. By preliminarily pressure-molding the layer, an electrode (e.g. cathode) is preliminarily formed.

Next, the upper male mold 701 is removed from the cylindrical hole 703 of the female mold 702, and then an electrolyte material is filled into the cylindrical hole 703 to obtain a layer of electrolyte material (electrolyte layer). After the surface of the layer is flatted, the upper male mold 701 is again inserted in the cylindrical hole 703. Thereafter, the layer of the electrolyte material is pressed preliminarily.

By doing so, the cathode and the electrolyte are joined preliminarily. Next, the upper male mold 701 is again removed from the cylindrical hole 703 of the female mold 702, and then an electrode mixture material (anode mixture material) is filled on the electrolyte pressed in the cylindrical hole 703 to obtain a layer of the electrode mixture material.

After the surface of the layer is flatted, the upper male mold 701 is again inserted in the cylindrical hole 703. Thereafter, the layer of the electrode mixture material is pressed preliminarily. Then, the upper male mold 701 is again removed from the cylindrical hole 703 of the female mold 702, a collector with a lead board 801 as shown in FIG. 8 is set so that the lead board thereof is placed in the upper side in FIG. 7.

Thereafter, the upper male mold 701 is again inserted in the cylindrical hole 703, and then the materials and the collectors with the lead boards preliminarily joined in the cylindrical hole 703 are pressure-molded at a pressure being capable of joining the entirety thereof to obtain a molded body.

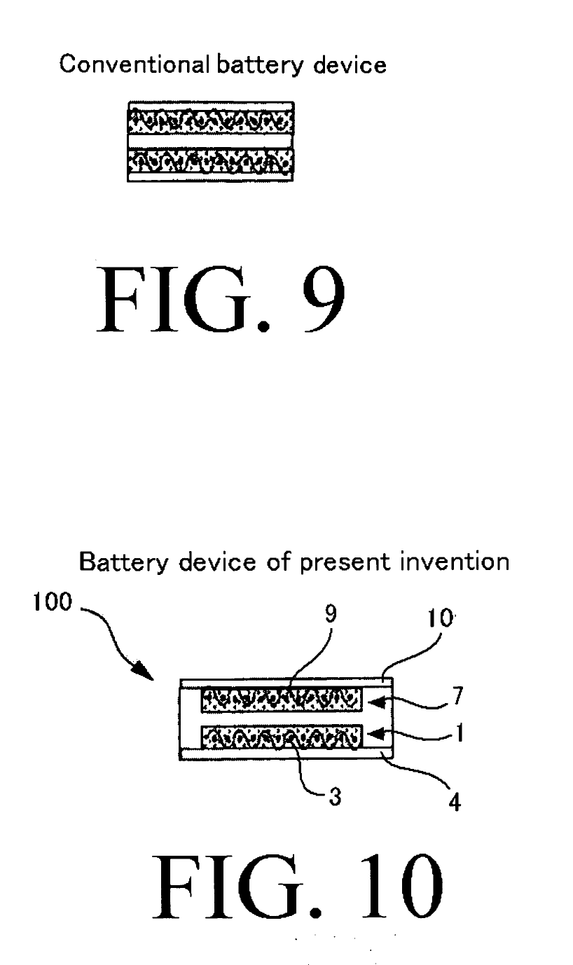

The thus obtained molded body is removed from the cylindrical hole 703 of the female mold 702 to thereby obtain a conventional battery device. A structure of the conventional battery device is shown in FIG. 9. When the conventional battery device is removed from the cylindrical hole 703 of the female mold 702, the side surface of the electrolyte layer included in the conventional battery device is contaminated by a cathode active material and an anode active material, thereby the many short-circuits occur between the cathode and the anode.

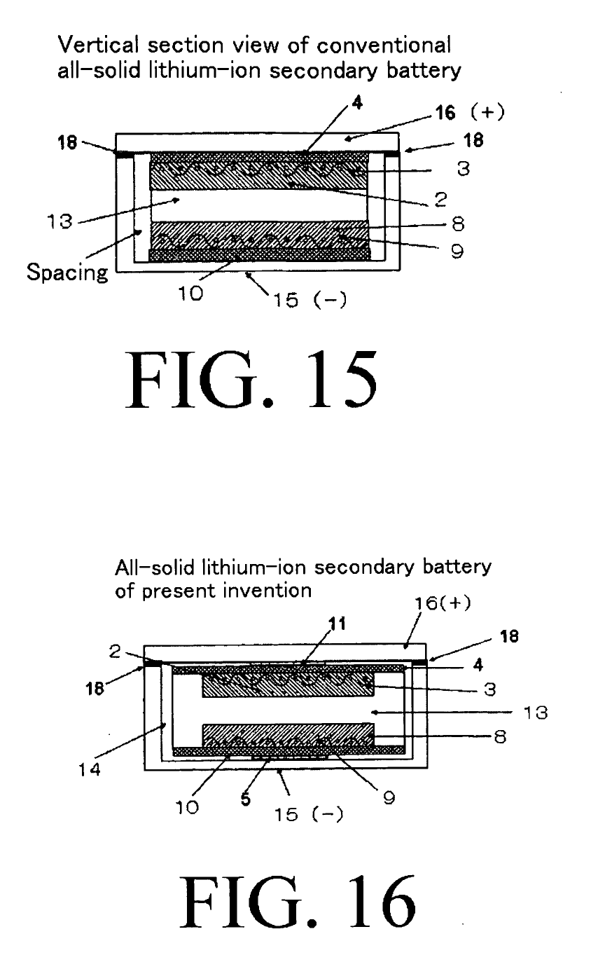

The thus obtained conventional battery device is placed into a battery container 15 (which serves an anode in the conventional battery device) so as to be a configuration as shown in FIG. 15 to obtain the conventional all-solid lithium-ion secondary battery. In this regard, a container obtained by subjecting entire surfaces of a stainless container or an iron container to a nickel plating treatment is used as such a battery container 15.

In many cases, the thus obtained conventional battery device is placed into a coin-type container. The same material as the material used in the battery container 15 is used as an upper lid 16 (which serves a cathode in the conventional battery device) of the battery container 15. The battery container 15 is sealed with the upper lid 16 in a state that they are insulated by an insulating resin or a packing.

In contrast, production of the battery device 100 of the present invention is carried out as follows.

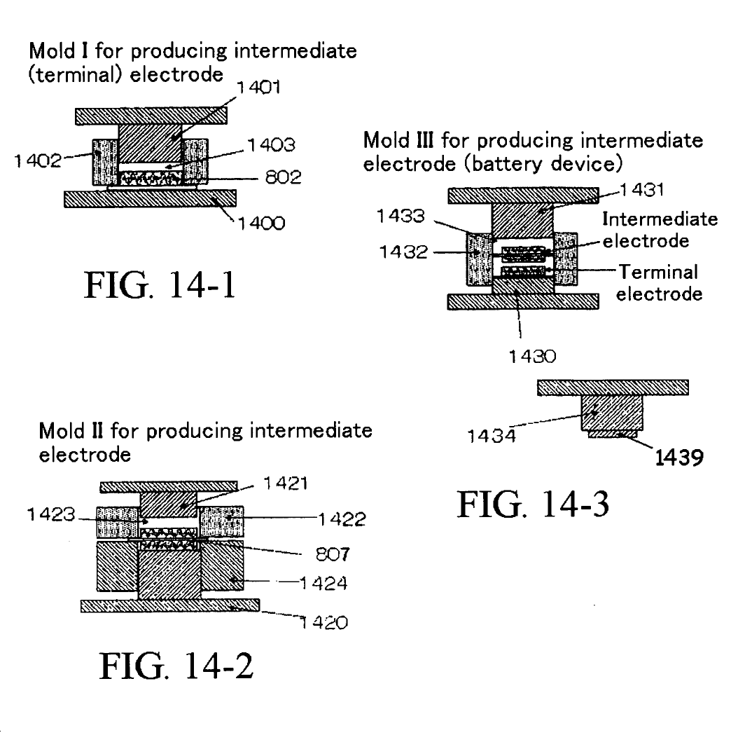

First, in a mold I (which has a metal plate 1400, an upper male mold 1401 and a female mold 1402) shown in FIG. 14, a collector with a lead board 802, 803 or 804 shown in FIG. 8 is set on the metal plate 1400 so that the lead board thereof is in contact with the metal plate 1400. In a state that the female mold 1402 is set on the lead board so as to surround the collector, an electrode mixture material (cathode mixture material) is filled in a cylindrical hole 1403 of the female mold 1402 to obtain a layer of the cathode mixture material.

After the layer is flatted, the layer is pressure-molded preliminarily to obtain the electrode (cathode 1). The thus obtained cathode with the lead board is removed from the mold to prepare a terminal electrode (cathode 1) with the lead board for use in the all-solid lithium-ion secondary battery 200 of the present invention. In this regard, it is to be noted that a terminal electrode (anode 7) with a lead board is also produced in the same manner.

Next, an intermediate electrode needed to produce a secondary battery of a laminate type is produced by using a mold II (which has a lower male mold 1420, an upper male mold 1421, a female molds 1422 and 1424) shown in FIG. 14-2. The lower male mold 1420 is inserted into the female mold 1424 so that a space in which an electrode mixture material is filled is formed. The electrode mixture material (anode mixture material) is filled into the space to obtain a layer of the anode mixture material.

After the layer is flatted, a collector with a lead board 807 shown in FIG. 8 is placed on the layer. Next, the female mold 1422 having a cylindrical hole 1423 is set on the lead board of the collector with the lead board 807 so as to surround the collector thereof. Then, an electrode mixture material (anode mixture material) is filled in the cylindrical hole 1423 to obtain a layer of the anode mixture material.

After the layer is flatted, an upper male mold 1421 is inserted into the cylindrical hole 1423. Thereafter, by pressure-molding the materials and the collector with the lead board 807 in the cylindrical hole 1423, the intermediate electrode used in the present invention is formed.

In FIG. 14-2, the female molds 1422 and 1424 are drawn so that the female mold 1422 is not fixed with the female mold 1424. However, in fact, the female mold 1422 is detachably fixed with the female mold 1424 by clips. Further, it is obvious that a split mold obtained by using both the female molds 1422 and 1424 makes it possible to produce the intermediate electrode by itself.

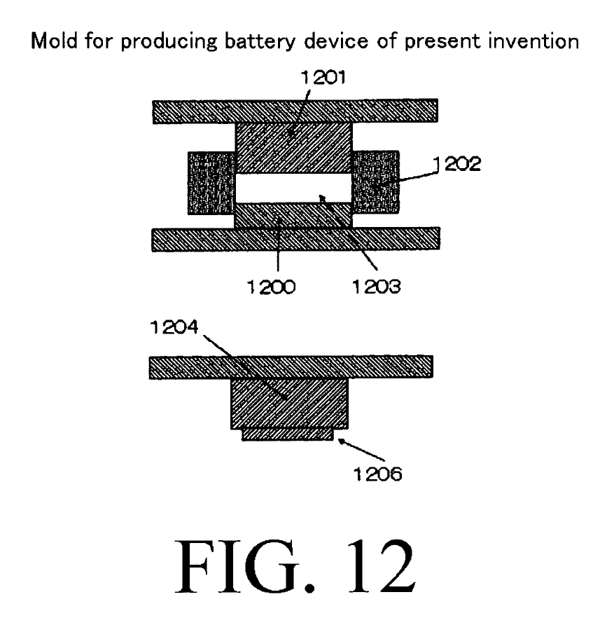

The battery device 100 using the thus obtained the terminal electrodes and the thus obtained intermediate electrode is produced by the following molding steps. First, an electrolyte 13 is molded by using a mold (which has a lower male mold 1200, an upper male mold 1201, a female mold 1202 and an upper male mold 1204) shown in FIG. 12. Thereafter, the battery device 100 is produced as follows.

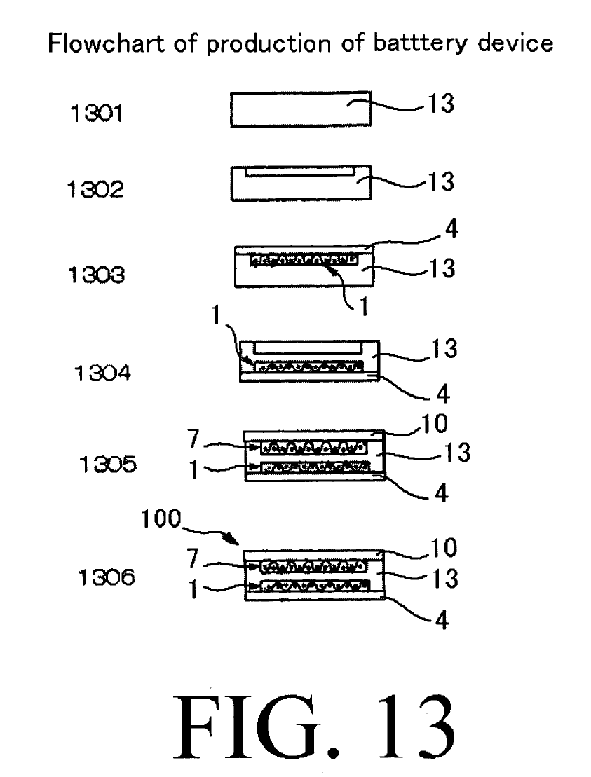

That is to say, (I) an electrolyte material is filled into a cylindrical hole 1203 of the female mold 1202 in a state that the lower male mold 1200 is inserted into the cylindrical hole 1203 of the female mold 1202 to obtain a layer of an electrolyte 13. Then, the surface of the layer of the electrolyte 13 is flatted (in this state, the layer of the electrolyte 13 is shown by the step 1301 in FIG. 13.).

(II) Thereafter, the upper male mold 1204 having a convex portion 1206 for forming a space portion (concave portion) capable of receiving an electrode is inserted to the cylindrical hole 1203 of the female mold 1202. Then, the layer of the electrolyte 13 is pressed at weak power by the upper mold 1204 to form a concave portion (in this state, the layer of the electrolyte 13 is shown by the step 1302 in FIG. 13.).

(III) The upper male mold 1204 is removed from the cylindrical hole 1203 of the female mold 1202, and then the terminal electrode (cathode 1) with the lead board produced as described above is set into the concave portion so that the cathode active material contained in the cathode 1 is in contact with the electrolyte 13.

Thereafter, the cathode 1 with the lead board is preliminarily pressure-molded by the upper male mold 1201 (in this state, the cathode 1 is joined with the electrolyte 13 in the concave portion, which is shown by the step 1303 in FIG. 13.). Next, in this state, the mold is turned over, and then the lower male mold 1200 is removed from the cylindrical hole 1203 of the female mold 1202.

(IV) Another upper male mold 1204 is inserted into the cylindrical hole 1203 of the female mold 1202. Then, a concave portion for receiving an electrode is formed on the other surface of the layer of the electrolyte 13 in the same manner as the above item (II) (in this state, the layer of the electrolyte 13 is shown by the step 1304 in FIG. 13).

(V) The terminal electrode (anode 7) with the lead board produced as described above is set into the concave portion so that the anode active material contained in the anode 7 is in contact with the electrolyte 13. The anode 7 with the lead board is preliminarily pressure-molded by the lower male mold 1200 to obtain a battery device 100 (in this state, the anode 7 is joined with the electrolyte 13 in the concave portion, which is shown by the step 1305 in FIG. 13.).

(VI) The thus obtained battery device 100 is removed from the mold. In this way, the battery device 100 of the present invention is produced (in this state, the battery device 100 is shown by the step 1306 in FIG. 13.).

The all-solid lithium-ion secondary battery 200 of the laminate type can be also produced in the same manner as described above. FIG. 14-3 shows the production process of the all-solid lithium-ion secondary battery 200 of the laminate type including terminal electrodes and an intermediate electrode by using a mold III.

In the molding steps described above, a pressure for pressure-molding is preferably 2 ton/cm² or larger, more preferably 3 ton/cm² or larger, and even more preferably 5 ton/cm² or larger. This makes it possible to reliably press the electrode mixture material. Further, it is possible to reliably fill the electrode mixture material into through-holes provided in the collector 3 (collectors with the lead boards 801 to 808 shown in FIG. 8). A constituent material of the various molds used for producing the battery device 100 is not limited to metal but may be resin or ceramics.

Next, a method of producing a battery device 100 and an all-solid lithium-ion secondary battery 200 according to the present invention will be described one by one by using a flow chart shown in FIG. 6.

A Step of Production of Electrodes (601)

First, three collectors with lead boards shown in FIG. 8 which are needed to produce electrodes (cathode, anode and intermediate electrode) are prepared. That is, two collectors of the three collectors with lead boards are used in terminal electrodes. One collector of the three collectors with lead boards is used in an intermediate electrode for forming a secondary battery of a laminate type.

(i) Step of Production of Terminal Electrodes

In a mold I shown in FIG. 14-1, either a collector with a lead board 802, 803 or 804 shown in FIG. 8 is placed on the surface of a metal plate 1400 so that the lead board thereof is in contact with the surface of the metal plate 1400. In a state that a female mold 1402 is set on the lead board so as to surround the collector thereof, an electrode mixture material (cathode mixture material) is filled into a cylindrical hole 1403 of the female mold 1402 to obtain a layer of the cathode mixture material.

After the layer is flatted by using an upper male mold 1401, the layer is preliminarily pressing-molded to obtain an electrode (cathode 1). The thus obtained cathode 1 with the lead board (cathode lead board 4) is removed from the mold to obtain a terminal electrode (cathode 1) with the cathode lead board 4 for use in the all-solid lithium-ion secondary battery 200 of the present invention. In this regard, it is to be noted that another terminal electrode (anode 7) with lead board is obtained in the same manner as described above.

(ii) Step of Production of Intermediate Electrode

In a production of a secondary battery of a laminate type, an intermediate electrode needed thereto is produced by using a mold shown in FIG. 14-2. A lower male mold 1420 is inserted in a female mold 1424 so that a space in which an electrode mixture material is filled is formed. An electrode mixture material (anode or cathode mixture material) is filled into the space to obtain a layer of the electrode mixture material.

After the layer is flatted, a collector with a lead board 807 is placed on the layer. Next, a female mold 1422 having a cylindrical hole 1423 is set on the lead board of the collector with a lead board 807 so as to surround the collector thereof, and then another electrode mixture material (cathode or anode mixture material) is filled into the cylindrical hole 1423 to obtain a layer of another electrode mixture material.

After the layer is flatted, an upper male mold 1421 is inserted in the cylindrical hole 1423 of the female mold 1422. By pressure-molding the materials and the collector with the lead board 807, an intermediate electrode for use in the laminate type secondary battery of the present invention is formed (FIGS. 5-3 to 5-6).

B Step of Joining Terminal Electrodes and Electrolyte Together (602)

Next, female molds 1202 and 1432 shown in FIG. 12 and FIG. 14-3 of which inner diameters are larger than an inner diameter of the cylindrical hole 703 of the female mold 702 used in production of the conventional battery device as described above are prepared as a mold for producing an electrolyte 13.

The electrolyte 13 is filled into the cylindrical hole 1203 of the female mold 1202 in a state that a lower male mold 1200 is inserted into a cylindrical hole 1203. On the other hand, the electrolyte 13 is filled into a cylindrical hole 1433 of the female mold 1432 in a state that a lower male mold 1430 is inserted into the cylindrical hole 1433.

Next, an upper male mold 1204 provided with a convex portion 1206 of forming a space (concave) portion for inserting an electrode is inserted into the cylindrical hole 1203 of the female mold 1202. Then, the electrolyte 13 is preliminarily pressing-molded by the upper male mold 1204 to obtain a layer of the electrolyte 13 having the concave portion which is capable of receiving an electrode.

Thereafter, the upper male mold 1204 is removed from the cylindrical hole 1203 of the female mold 1202, and then the terminal electrode (cathode 1) of the terminal electrode with the lead board produced in the A step is inserted (set) into the concave portion. Then, an upper male mold 1201 having no convex portion is inserted into the cylindrical hole 1203 of the female mold 1202.

Thereafter, the cathode 1 with the lead board (cathode lead board 4) is preliminarily pressure-molded by the upper male mold 1201 to join the cathode 1 and the electrolyte 13 together in the concave portion. As a result, the cathode 1 is covered by the electrolyte 13.

In this regard, it is to be noted that the terminal electrode is also joined with the electrolyte 13 in the concave portion by using the mold III shown in FIG. 14-3 in the same manner as the use of the mold shown in FIG. 12. Further, it is to be noted that the terminal electrode (anode) is also joined with the electrolyte 13 in the concave portion in the same manner as described above.

C Step of Production of Battery Device (603)

Next, in a state that a molded body in which the cathode 1 is joined with the electrolyte 13 is not removed from the molds, the molds (FIG. 12 and FIG. 14) are turned over. In other words, in a state that the upper male mold 1201 and the lower male mold 1200 are inserted into the cylindrical hole 1203 of the female mold 1202, the mold shown in FIG. 12 is turned over. Likewise, in a state that the upper male mold 1431 and the lower male mold 1430 are inserted into the cylindrical hole 1433 of the female mold 1432, the mold shown in FIG. 14-3 is turned over.

Thereafter, the lower male mold 1200 turned over in the upper side of FIG. 12 is removed from the cylindrical hole 1203, and then the upper male mold 1204 with a convex portion 1206 of forming a space (concave) portion for inserting an terminal electrode is inserted in the cylindrical hole 1203 of the female mold 1202 so as to be in contact with the surface of the electrolyte 13. Then, the electrolyte 13 is preliminarily pressure-molded by the upper male mold 1204 to obtain the concave portion which is capable of receiving the terminal electrode (anode).

Thereafter, the upper male mold 1204 is removed from the cylindrical hole 1203 of the female mold 1202, and then the terminal electrode of the terminal electrode with the lead board produced in the A step is inserted (set) into the concave portion. Then, the upper male mold 1201 having no convex portion is again inserted into the cylindrical hole 1203.

Thereafter, the terminal electrode (anode 7) with the lead board (anode lead board 10) is pressure-molded at a predetermined pressure to produce a battery device 100 of which cathode 1 and anode 7 are covered by the electrolyte 13.

In this regard, it is to be noted that the battery device 100 is also produced by using the mold shown in FIG. 14-3 in the same manner as the use of the mold shown in FIG. 12.

Next, in the case where a battery device 100 of a laminate type is produced, the mold III shown in FIG. 14-3 is used.

In the present embodiment, the intermediate electrodes (FIG. 5-3 to FIG. 5-6) produced in the A-(ii) step are used as an insertion electrode. The intermediate electrodes shown in FIG. 5-3 to FIG. 5-6 can be used in a battery device 100 of a parallel laminate type. Further, the intermediate electrodes shown in FIG. 5-5 and FIG. 5-6 can also be used in a battery device 100 of a series laminate type.

The both battery devices 100 of the parallel laminate type and the series laminate type are produced as follows.

In the production of the battery device 100 (603) described above, first, the intermediate electrode produced in the A-(ii) step is inserted in the concave portion of the electrolyte 13 in stead of the terminal electrode (anode 7) with lead board to obtain a molded body. Then, the molded body is preliminarily pressed by using the upper male mold 1431.

Thereafter, the upper male mold 1431 is removed from the cylindrical hole 1433 of the female mold 1432, and then the electrolyte 13 is filled in the cylindrical hole 1433 to obtain a layer thereof. Then, the surface of the layer of the electrolyte 13 is flatted, and then the upper male mold 1434 with a convex portion 1439 is inserted in the cylindrical hole 1433 of the female mold 1432 so as to be in contact with the surface of the layer of the electrolyte 13.

Thereafter, the electrolyte 13 is preliminarily pressure-molded by the upper male mold 1434 to obtain a concave portion which is capable of receiving the terminal electrode (anode). Thereafter, the upper male mold 1434 is removed from the cylindrical hole 1433 of the female mold 1322, and then the terminal electrode of the terminal electrode with the lead board produced in the A-(i) step is inserted into the concave portion.

Further, the upper male mold 1431 having no convex portion is inserted into the cylindrical hole 1433. Thereafter, the terminal electrode (anode 7) with the lead board (anode lead board 10) is pressure-molded at a predetermined pressure. As a result, a battery device 100 of a two cells laminate type, of which cathode 1 and anode 7 are covered by the electrolyte 13, is produced.

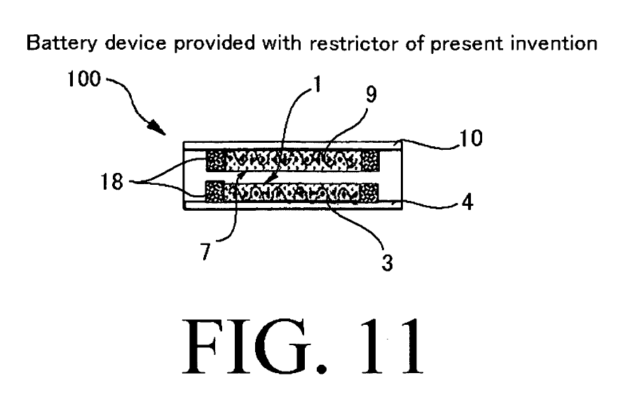

The thus obtained battery device 100 is shown in FIG. 10 as a configuration view (with a schematical view). In this regard, it is to be noted that the battery device 100 obtained by using the terminal electrodes with the lead boards and the restrictors 18 as shown in FIG. 5-2 is shown in FIG. 11.

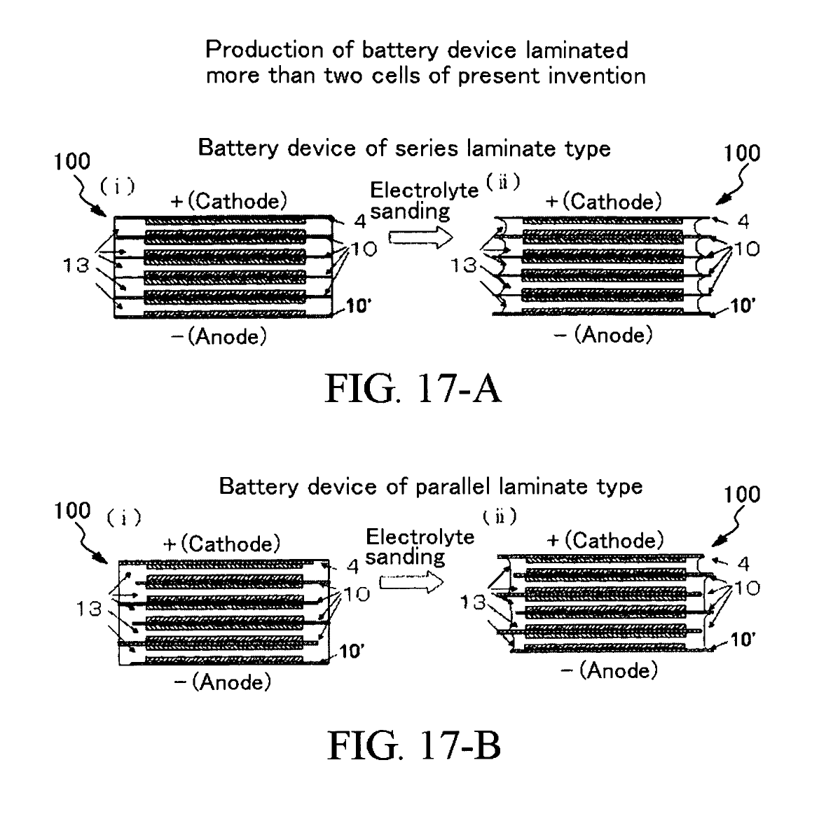

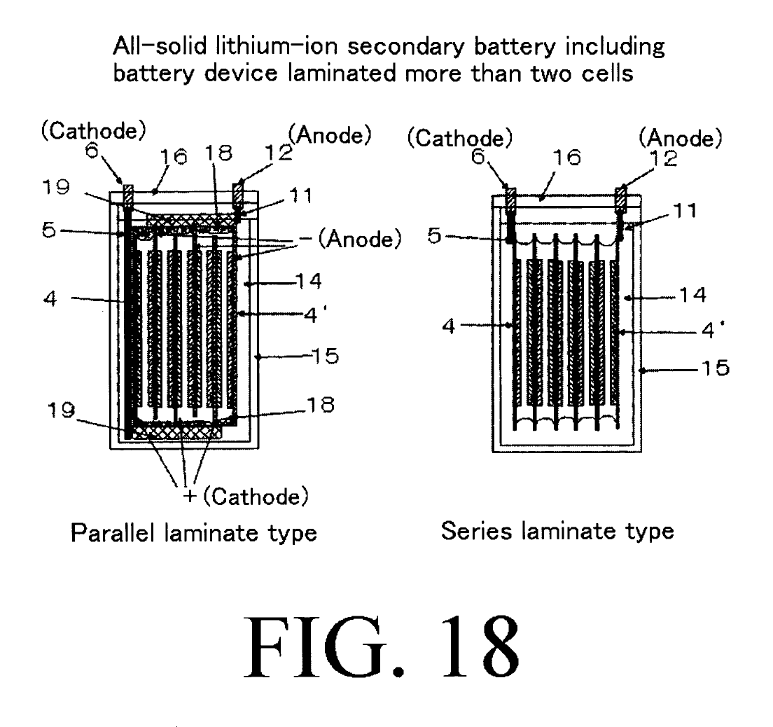

Further, the battery device 100 of a five cells series laminate type is shown in FIG. 17-A. Furthermore, the battery device 100 of a five cells parallel laminate type is shown in FIG. 17-B.

In the battery device 100 of the parallel laminate type as shown in FIG. 17-B, each of the cathode connection lead 5 and the anode connection lead 11 having different length thereof is preliminarily provided to both peripheral end portions of the cathode lead board 4 and the anode lead board 10 for electrically connecting the cathode 1 to the cathode lead board 4 and the anode 7 to the anode lead board 10 as a cathode lead and an anode lead, respectively.

In the A to C steps, a pressure to pressure-mold the materials, the electrolyte 13, the collectors with the lead boards (molded body) is preferably 2 or larger, more preferably 3 ton/cm² or larger, and even more preferably 5 ton/cm² or larger. This makes it possible to sufficiently press the molded body and cover the cathode 1 and the anode 7 with the electrolyte 13 in the battery device 100. Therefore, it is possible to reliably join the cathode 1 or the anode 7 and the electrolyte 13 together.

As a result, it is possible to reliably prevent occurrence of short-circuit between the cathode 1 and the anode 7 in the produced battery device 100, thereby producing the battery device 100 having constant battery-performance. By using such a battery device 100 having constant battery-performance, it is possible to produce all-solid lithium-ion secondary batteries 200 of a parallel laminate type and a series laminate type each having constant battery performance.

If needed, a mold release agent may be in advance applied to the inner surfaces of the cylindrical holes 1203, 1403, 1423 and 1433 of the female molds 1202, 1402, 1422 and 1432 used in the A to C steps. The mold release agent is used for improving release property of the produced battery device 100.

D Step of Connection between Lead Boards and Electrode End Terminals (604)

This step will be described by using the battery device 100 shown in FIG. 1. The cathode lead board 4 and the anode lead board 10 of the battery device 100 obtained in the C step are connected with the electrode end terminal 6 and the electrode end terminal 12 provided on the upper lid 16 through the cathode connection lead 5 and the anode connection lead 11 each having conductive property, respectively.

In each of the battery devices 100 of the laminate type as shown in FIG. 17-A and FIG. 17-B, both peripheral end portions of the cathode lead boards 4 and the anode lead boards 10 are laminated through the electrolyte 13, which is different from that of the battery device 100 shown in FIG. 1. Therefore, it is difficult that the cathode connection lead 5 and the anode connection lead 11 are connected with the cathode lead boards 4 and the anode lead boards 10 of the produced battery device 100 of the laminate type, respectively.

As a result, in order to connect the cathode connection lead 5 and the anode connection lead 11 with the cathode lead boards 4 and the anode lead boards 10 in such a battery device 100 of the laminate type, the electrolyte 13 existing in the both peripheral end portions of the cathode lead boards 4 and the anode lead boards 10 needs to be removed.

In the present embodiment, such an electrolyte 13 is removed by using a metal brush. In such removal, a sandblast treatment can be used preferably. This is because a large amount of the electrolyte 13 can be removed by one sandblast treatment. After the electrolyte 13 existing in the both peripheral end portions of the cathode lead board 4 and the anode lead board 10 is subjected to the sandblast treatment, shapes of both peripheral end portions thereof are shown in FIG. 17-A (ii) and FIG. 17-B (ii).

In the battery device 100 of the parallel laminate type, it is not always necessary to carry out the sandblast treatment to the electrolyte 13. However, the sandblast treatment is preferable due to good connection between the battery device 100 of the parallel laminate type and a fixing material in a sealing step described later.

On the other hand, in the battery device 100 of the series laminate type, the sandblast treatment plays a major role in that a plurality of electrodes (intermediate electrodes) are bundled together so that they can be led out from the battery device 100 easily (FIG. 17-A-(ii)).

It is possible to easily achieve the bundling the plurality of electrodes together so that they can be led out from the battery device 100 of the series laminate type by using a metalikon thermal-spray apparatus placed in each side of the electrode end terminals (6, 12) and spraying a conductive metal to the bundled electrodes at a time.

The cathode lead board 4 and the anode lead board 10 of the thus produced battery device 100 are connected with the cathode end terminal 6 and the anode end terminal 12 (hermetic end terminals), respectively, through the cathode connection lead 5 and the anode connection lead 11 which are joined to the upper lid 16 with an insulating material.

Next, an insulating material constituting the fixed portion 14 is preliminarily filled into the battery container 15. Thereafter, the battery device 100 in which the cathode lead board 4 and the anode lead board 10 are connected with the cathode end terminal 6 and the anode end terminal 12, respectively through the cathode connection lead 5 and the anode connection lead 11 is placed into the battery container 15.

In the case where the fixed portion 14 is made of, e.g., hot-melt resin (a hot-melt adhesive agent) or a low-melting-point glass, it is possible to form the fixed portion 14 by melting or softening the hot-melt resin or the low-melting-point glass, supplying the battery device 100 in the battery container 15 and allowing the same to be cooled down and solidified. This method ensures that the fixed portion 14 is reliably formed so as to cover almost all of the battery device 100.

Examples of a constituent material of each of the battery container 15 and the upper lid 16 include: various kinds of metallic materials such as aluminum, copper, brass and stainless steel; various kinds of resin materials; various kinds of ceramics materials; various kinds of glass materials; various kinds of composite materials consisting of metal and resin; and the like.

The cathode active material and the anode active material are not particularly limited to the ones noted above. There is no problem if a material exhibiting electropositive potential against the anode active material is selected as the cathode active material through the combination of the afore-mentioned materials. By adopting such a configuration, it is possible to provide the all-solid lithium-ion secondary battery 200 having an arbitrary discharge voltage.

Furthermore, it is preferred that a sulfide-based lithium-ion conductor or a mixture containing the sulfide-based lithium-ion conductor is used as the (solid) electrolyte material.

Examples of the sulfide-based lithium-ion conductor to be used as the electrolyte material include: a glass of conducting a lithium ion such as Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—B₂S₃—LiI, Li₂S—P₂S₅, Li₂S—P₂S₅—LiI, Li₂S—P₂S₅-ZₘSₙ (Z=Ge, Zn, Ga), Li₂S—GeS₂, Li₂S—SiS₂—Li₃PO₄, Li₂S—SiS₂—LiₓPO_{y} (M=P, Si, Ge, B, Al, Ga, In); a crystalline material of conducting a lithium ion containing these glasses; a material of conducting a lithium ion which constituted of a mixture of these glasses and crystalline material; and the like.

Furthermore, it is preferred that the sulfide-based lithium-ion conductor contains at least one of a crystalline material and an amorphous material. The lithium ion conductor constituted of the crystalline material is a material that endows the electrolyte 13 with the most superior lithium ion conductivity and exhibits good moldability. Therefore, use of the lithium ion conductor constituted of the crystalline material in producing the secondary battery provides an advantage that the output current density can be kept high.

On the other hand, since the lithium ion conductor constituted of the amorphous material does not give anisotropic conductivity to the material made therefrom, it is possible to maintain the ion-conducting path to the electrode active material in a good state. Further, since the lithium ion conductor constituted of the amorphous material has high heat stability, the lithium ion conductor constituted of the amorphous material has an advantage in that superior preservability is exhibited after producing the all-solid lithium-ion secondary battery 200.

If the lithium ion conductors constituted of the crystalline material and the amorphous material are used in combination, it becomes possible to expect all the advantages offered by them.

E Step of Sealing of Battery Device (605)

Next, the upper lid 16 is put on the top of the battery container 15 to thereby completely join the upper lid 16 and the battery container 15 by a laser welding method. Alternatively, as easier method in this step, a packing may be put between the upper lid 16 and the battery container 15, thereby sealing the inside of the battery container 15 by a press sealing method.

In the case where a secondary battery 200 is produced by using the battery device 100 of the series laminate type, when a number of a cell included in the secondary battery 200 and having an operating voltage Va is n, an battery operating voltage Vt in the whole secondary battery is Va×n (in the present embodiment, the battery operating voltage Vt is 2Va due to the two cells shown in FIG. 4). A predetermined battery operating voltage can be selectively obtained by changing the number n of the cells.

Meanwhile, consideration is made with regard to the assumption case where a secondary battery is produced using laminated ten cells each having a structure similar to the battery device 100 as shown in FIG. 1. In this secondary battery, it is also assumed that each cell has electrodes (cathode and anode) constituted of the same kind of an electrode active material, and the adjacent cells are partitioned by partitioning walls each having a thickness same as that of its lid 16 (300 μm in this case).

Therefore, this secondary battery uses nine partitioning walls and the total thickness of the nine partitioning walls is 2.7 mm. Further, it is also assumed that each cell can generate a battery operating voltage of Vt, and therefore the secondary battery can generate as a whole a battery operating voltage of 10×Vt.

On the other hand, consideration is also made with regard to the other assumption case where a secondary battery that can generate the same battery operating voltage (10×Vt) is produced using the secondary battery 200 according to the present invention, that is, using the laminate type secondary battery 200 provided with the intermediate electrodes 4 (10) as described above. In this case, each intermediate electrode 10 includes a collector 3 (9) of which thickness is 50 μm or less.

Therefore, since nine intermediate electrodes 10 are used in this secondary battery, the total thickness of the nine collectors 3 (9) is only 0.45 mm or less (50 μm×9). As a result, as compared to the first assumed secondary battery provided with the ten cells, the secondary battery according to the present invention can reduce its thickness by 2.25 mm at the maximum (that is, 2.7 mm−0.45 mm). This also makes it possible to considerably reduce the total weight of the secondary battery as compared to the first assumed secondary battery.

Generally, a large amount of the electrode active material can be used in an electrode, namely used to improve a capacity of a battery. However, in a secondary battery of the laminate type, use of such a large amount of the electrode active material increases the thickness of electrodes included therein. As a result, there is a case that the ion-conducting path between the electrolyte and the electrodes is broken and impedance in the electrodes is increased.

Therefore, even if the large amount of the electrode active material is used for the electrodes, it is difficult to increase the capacity of the secondary battery of the laminate type to such an extent that should be expected by the increased amount thereof. As a result, use of the large amount of the electrode active material involves a demerit such as a lower efficiency of the secondary battery of the laminate type.

In order to avoid such a demerit, there may be conceived that an assembled battery is produced by placing a plurality of battery devices (cells) each having thin electrodes (low amount of an electrode active material) into a battery container and connecting the adjacent cells in parallel. However, in this case, a partitioning wall for connecting the adjacent cells exists between the adjacent cells. Further, a thickness of the partitioning wall is generally about 300 μm.

Therefore, a space of the battery container for receiving the battery devices (cells) expands in a thickness direction thereof. Further, a weigh of the battery container is also increased. Furthermore, if the thickness of the electrode is too thin, the electro-conducting path from the electrode active material constituting the electrodes to the electrolyte is broken in a manufactured all-solid lithium secondary battery, which is different from a battery using a normal liquid or a polymer electrolyte.

In contrast, the battery device 100 of the present invention has optimal thicknesses of the electrodes to be needed to laminate the electrodes. The thickness of each electrode is preferably in the range of 30 to 500 μm, and more preferably in the range of 50 to 200 μm. Since the battery device 100 of the present invention includes the electrodes each having such a thickness within above noted range, it is possible to maintain low impedance of the battery device 100.

Further, it is also possible to reliably improve a discharge capacity C of a secondary battery 200 by increasing a number of the cell included in the battery device 100. Therefore, it is possible to obtain a secondary battery having superior charge-discharge performance at a high output current density as compared to an electric cell which uses the same amount of the electrode active material as that of the secondary battery 200.

While the battery device and the all-solid lithium-ion secondary battery in accordance with the present invention has been described with reference to the illustrated embodiments, the invention is not limited thereto. Individual parts constituting the battery device and the all-solid lithium-ion secondary battery may be substituted by other arbitrary ones capable of performing similar functions. Moreover, arbitrary structural parts may be added if necessary.

### EXAMPLES

Next, description will be made with regard to experimental examples of the present invention.

### Example 1

A secondary battery including a battery device of the present invention (FIG. 16) was produced as described above. The battery device of which electrodes were formed on lead boards so as to be covered with an electrolyte provided therebetween was produced as described above.

In this regard, lithium cobaltate was used as a cathode active material. A ternary-based sulfide-lithium ion conducting glass constituted of Li₂S, SiS₂, and LiPO₄ was used as an electrolyte. The lithium cobaltate and the ternary-based sulfide-lithium ion conducting glass were mixed at a weight ratio of 7:3 to obtain a cathode mixture material. A cathode was produced by using the cathode mixture material. A diameter of the produced cathode was 16 mm and a thickness of the produced cathode was about 250 μm.

A diameter of the electrolyte consisted of the ternary-based sulfide-lithium ion conducting glass and filled into a spacing between the electrodes was 18 mm and a thickness of the electrolyte was about 300 μm. Indium powder (of which particle size was 5 μm) was used as an anode active material. The indium powder and the electrolyte were mixed at a weight ratio of 5:5 to obtain an anode mixture material. An anode was produced by using the anode mixture material. A diameter of the anode was 16 mm and a thickness of the anode was about 150 μm.

A thickness of a mesh member constituting a collector was 100 μm. A titanium thin film having a thickness of 300 μm was used as a cathode lead board and an anode lead board. In this regard, a sum of the thicknesses of the cathode and the cathode lead board was used as the thickness of the cathode and a sum of the thicknesses of the anode and the anode lead board was used as the thickness of the anode.

Ten all-solid lithium-ion secondary batteries (FIG. 16) were produced based on the embodiment described above so as to have the sizes of the parts described above. Each of the produced ten all-solid lithium-ion secondary batteries had no short-circuit between the cathode and the anode.

In order to examine characteristics of the produced ten all-solid lithium-ion secondary batteries, each produced all-solid lithium-ion secondary battery was charged at a constant current of 100 μA/cm². When a current became 30 μA after a charge voltage reached 3.8 V, the charge was stopped. After a lapse of 30 minutes from the charge stooping time, discharge was started at the same current as that of the charge.

As a result, a discharge capacity was constant in the range of about 3.5 to 3.0 V of a discharge voltage. The discharge capacity of about 110 mAh/gr was obtained in all the produced ten all-solid lithium-ion secondary batteries. Values of these discharge capacities were close to a theory value of a discharge capacity of lithium cobaltate.

### Comparative Example 1

In order to examine effects of the Example 1, ten all-solid lithium-ion secondary batteries (FIG. 15) were produced by a conventional method. A constituent material of each part of the ten all-solid lithium-ion secondary batteries was same as that of the Example 1. A cathode of which diameter was 16 mm and thickness was about 250 μm was formed on a cathode lead board.

The cathode with the cathode lead board was placed into a mold, and then the same electrolyte as that of Example 1 was filled into the mold and pressed by the mold to obtain an electrolyte layer so that a diameter of the electrolyte layer was 16 mm and a thickness of the electrolyte layer was 300 μm. On the other hand, indium powder (of which particle size was 5 μm) as an anode active material was mixed with the electrolyte at a weight ratio of 5:5 to obtain an anode mixture material.

An anode was formed on an anode lead board by using the obtained anode mixture material and a collector so that a thickness of the anode was 150 μm. The anode with the anode lead board was set in the mold. Then, the cathode with the cathode lead board, the electrolyte layer and the anode with the anode lead boar were pressure-molded to obtain a battery device. A thickness of a mesh member of the used collector was 100 μm.

A titanium thin film having a thickness of 300 μm was used as the cathode lead board and the anode lead board. In this regard, a sum of the thicknesses of the cathode and the cathode lead board was used as the thickness of the cathode and a sum of the thicknesses of the anode and the anode lead board was used as the thickness of the anode.

Ten all-solid lithium-ion secondary batteries shown in FIG. 15 were produced by using the thus obtained battery devices. As a result, short-circuit between the cathode and the anode occurred in 90% of all the battery devices when the all-solid lithium-ion secondary batteries were produced.

It was observed in a visible manner that cause of the short-circuit was because side surfaces of the cathode, electrolyte layer and anode were contaminated by the cathode active material and the anode active material. Therefore, the side surfaces were sanded by a sand paper to thereby remove the cathode mixture material and the anode mixture material to obtain battery devices. Then, all-solid lithium-ion secondary batteries including such battery devices were produced. As a result, short-circuit between the cathode and the anode occurred in 50% of all the produced battery devices.

Ten all-solid lithium-ion secondary batteries shown in FIG. 15 were produced by using the other 50% of the produced battery devices in which the short-circuit did not occur between the cathode and the anode by sanding the side surfaces thereof. The produced all-solid lithium-ion secondary batteries were evaluated to check their charge-discharge characteristics in the same manner as the Example 1.

As a result, in a half number of the produced all-solid lithium-ion secondary batteries, short-circuit occurred in the process of the charge. Only 20% of the finally produced all battery devices could be normally discharged and could have a battery capacity matching with the theory.

Therefore, it was confirmed that the present invention had an effect that an all-solid lithium-ion secondary battery could be easily and reliably produced by using such a battery device.

### Example 2

In the case where the thicknesses of the cathode and the anode included in the battery device produced in the Example 1 were changed to various thicknesses, a discharge capacity of each battery device after charge of each battery device was examined and evaluated.

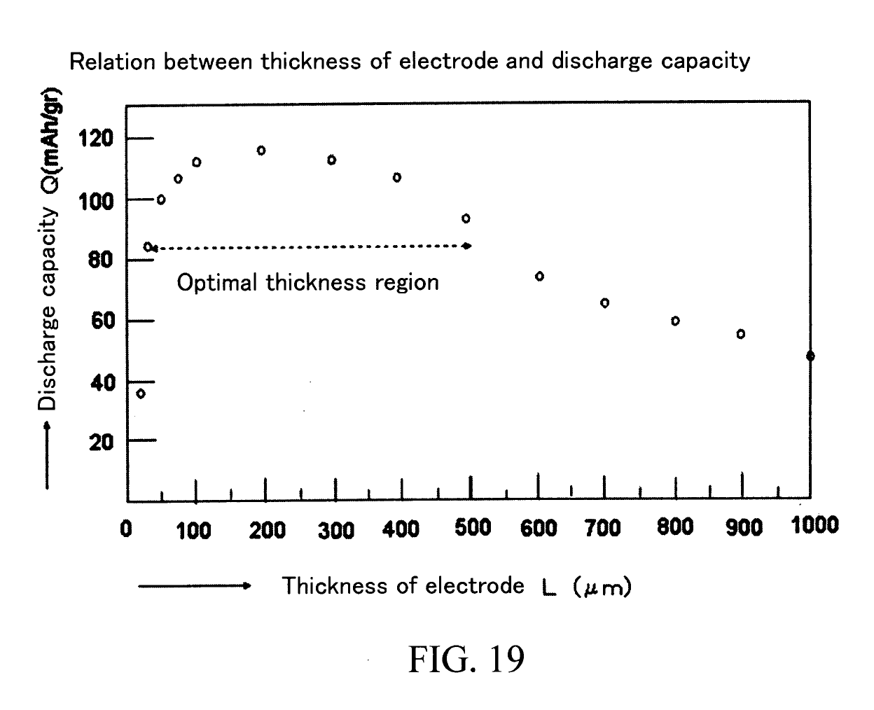

Battery devices were produced in the same manner as the Example 1 except that thicknesses of cathodes were changed as shown in FIG. 19. Then, all-solid lithium-ion secondary batteries were produced by using the battery devices. As a result, the thus produced all-solid lithium-ion secondary batteries had no short-circuit and were normal.

Charge-discharge characteristics of the all-solid lithium-ion secondary batteries were evaluated in the same manner as the Example 1. Discharge capacities of the all-solid lithium-ion secondary batteries were obtained at a voltage in the range of 3.7 V to 2 V at the end terminal. The discharge capacities of the all-solid lithium-ion secondary batteries in the range of 3.5 V to 3.0 V were constant.

The results were shown in FIG. 19. As shown in FIG. 19, the discharge capacities of the all-solid lithium-ion secondary batteries increased in accordance with increase of the thickness of the cathode, namely 15, 30, 50 to 75 μm. Then, the discharge capacities decreased when the thickness of the cathode was over 500 μm and then further decreased in accordance with increase of the thickness, namely 700, 800, 900 to 1,000 μm.

Therefore, it was confirmed that if the thickness of the cathode in each of the all-solid lithium-ion secondary batteries was set in the range of 30 to 500 μm, it was possible to obtain the discharge capacities of the all-solid lithium-ion secondary batteries which were close to a theory discharge capacity of lithium cobaltate. Further, it is also possible to efficiently exhibit battery performance, thereby obtaining an optimal all-solid lithium-ion secondary battery.

### Example 3

An all-solid lithium-ion secondary battery of a parallel laminate type which included a battery device having two cells (FIG. 3) was produced by the method of the embodiment described above. In the all-solid lithium-ion secondary battery, a cathode of which thickness was 250 μm was used, which was the same cathode as that of the Example 1.

An electrolyte of which diameter was 18 μm and thickness was 300 μm was used. An anode of which thickness was 150 μm was used, which was the same anode as that of the Example 1. A thickness of each of a cathode lead board and an anode lead board was 300 μm. An intermediate electrode shown in FIG. 5-3 was used. A thickness of a lead board of the intermediate electrode was 50 μm.

A thickness of a collector used in each of the cathode and the anode was 100 μm. The all-solid lithium-ion secondary battery of the parallel laminate type was produced by laminating the cathode with the cathode lead board, the electrolyte, the intermediate electrode, the electrolyte and the anode with the anode lead board in a mold in this order as described above.

In order to examine characteristics of produced all-solid lithium-ion secondary battery, the produced all-solid lithium-ion secondary battery was charged at a constant current of 100 μA/cm². When a current became 30 μA after a charge voltage reached 3.8 V, the charge was stopped. After a lapse of 30 minutes from the charge stooping time, discharge was started at the same current as that of the charge.

As a result, a discharge capacity was constant in the range of about 7.0 to 6.0 V of a discharge voltage. The discharge capacity of about 110 mAh/gr was obtained in the produced all-solid lithium-ion secondary battery in discharge to a voltage of 4.0 V at the end terminal.

### Comparative Example 2

In order to examine effects of the Example 3, five battery devices of a parallel laminate type were produced. In this regard, it is to be noted that an electrolyte layer was provided on the surfaces of both a cathode and an anode, but not provided on the side surfaces both the cathode and the anode. In this battery devices, a constituent material of each part was the same material as that the Example 3.

A diameter of each of the cathode, the anode and the electrolyte layer was 16 mm. Connection leads for preliminarily connecting the cathode lead board and the anode lead board with electrode end terminals were connected with the cathode lead board and the anode lead board, respectively.

Short-circuit occurred in all the produced five battery devices. Further, it was difficult due to existence of the connection leads that side surfaces of the cathode and the anode included in the battery device were sanded to thereby remove the electrode mixture material which adhered to the side surfaces.

As described above, it was difficult for the all-solid lithium-ion secondary battery produced by using the cathode having the thickness of 250 μm to obtain normal initial characteristics. This means, it is also difficult by using the conventional method to produce a secondary battery of a laminate type which includes the battery device of a many cells laminate type obtained by using electrodes having a thinner thickness. It is obvious that this is applied to the production of the battery devices of the laminate type as well as a production of a secondary battery of a laminate type.

### Example 4

Each of ten all-solid lithium-ion secondary batteries including a battery device was produced in the same manner as the Example 1 except that Li₂S—P₂S₅ based lithium ion conducting glass was used as an electrolyte and graphite instead of indium was used as an anode. That is, the battery device of which electrodes were formed on lead boards so as to be covered with the electrolyte provided therebetween was produced as described above.

In this regard, lithium cobaltate was used as a cathode active material. A binary-based sulfide-lithium ion conducting glass constituted of Li₂S and P₂S₅ was used as an electrolyte. The lithium cobaltate and the binary-based sulfide-lithium ion conducting glass were mixed at a weight ratio of 7:3 to obtain a cathode mixture material. A cathode was produced by using the cathode mixture material. A diameter of the produced cathode was 16 mm and a thickness of the cathode was about 250 μm.

A diameter of an electrolyte which was consisted of the binary-based sulfide-lithium ion conducting glass was 18 mm and a thickness of the electrolyte was about 300 μm. Graphite powder (of which particle size was 5 μm) was used as an anode active material. The graphite powder and the electrolyte were mixed at a weight ratio of 4:6 to obtain an anode mixture material. An anode was produced by using the anode mixture material. A diameter of the produced anode was 16 mm and a thickness of the anode was about 150 μm.

A thickness of a mesh member constituting a collector was 100 μm. A thickness of each of a cathode lead board and an anode lead board was 300 μm. Each of the mesh member, the cathode lead board and the anode lead board was made of a titanium alloy as a constituent material thereof. Ten all-solid lithium-ion secondary batteries (FIG. 16) were produced based on the embodiment described above so as to have the sizes of parts.

In order to examine characteristics of the produced ten all-solid lithium-ion secondary batteries, each produced all-solid lithium-ion secondary battery was charged at a constant current of 100 μA/cm². When a current became 30 μA after a charge voltage reached 4.2 V, the charge was stopped. After a lapse of 30 minutes from the charge stooping time, discharge was started at the same current as that of the charge.

As a result, a discharge capacity was constant at a discharge voltage in the range of about 3.9 to 3.4 V. The discharge capacity of about 110 mAh/gr was obtained in the produced ten all-solid lithium-ion secondary batteries in discharge of a voltage from 4.2 V to 2.5 V at an end terminal. Values of these discharge capacities were close to a theory value of a discharge capacity of lithium cobaltate.

### Example 5

Five all-solid lithium-ion secondary batteries each including a battery device were produced in the same manner as the Example 1 except that a sulfide-based lithium ion conductor constituted of a Li₂S—GeS₂—P₂S₅ based crystalline material was used as an electrolyte.

In order to examine characteristics of the produced five all-solid lithium-ion secondary batteries, each produced all-solid lithium-ion secondary battery was charged at a constant current of 100 μA/cm². When a current became 30 μA after a charge voltage reached 4.2 V, the charge was stopped. After a lapse of 30 minutes from the charge stooping time, discharge was started at the same current as that of the charge.

As a result, a discharge capacity was constant at a discharge voltage in the range of about 3.9 to 3.4 V. The discharge capacity of about 110 mAh/gr was obtained in all the produced five all-solid lithium-ion secondary batteries in discharge of a voltage of from 4.2 V to 2.5 V at an end terminal. Values of these discharge capacities were close to a theory value of a discharge capacity of lithium cobaltate.

From the results of each of the Examples 1 to 5 and the Comparative Examples 1 and 2, it was found that the all-solid lithium-ion secondary battery produced by using the battery device of the present invention (Examples 1 to 5) could exhibit stable performance. Further, in the all-solid lithium-ion secondary battery, the thicknesses of the cathode and the anode affected discharge performance after charge of the all-solid lithium-ion secondary battery.

Therefore, it was also found that such discharge performance could be maintained by setting the thicknesses of the anode and the cathode in the range of 25 to 500 μm as an optimal thickness. Furthermore, by covering the cathode and the anode with the electrolyte in the battery device, it was possible to completely eliminate occurrence of short-circuit between the cathode and the anode.

On the other hand, in the conventional method, it was confirmed that short-circuit was highly likely to occur in a side surface of the electrolyte layer provided between the electrodes in the case where thin electrodes were used or an electrode active material having a large particle size was used. Further, it was also confirmed that short-circuit was highly likely to occur in a peripheral portion of the electrolyte layer provided between the electrodes in the case where thick electrodes and thin electrolyte layer were used.

Therefore, the battery device of the present invention can improve yield of producing the battery device. In particular, in the case of producing the battery device of the laminate type, industrial worth in producing thereof is extremely high.

What is claimed is:

1. A battery device, comprising
a first lead board having one surface and the other surface;
a second lead board having one surface and the other surface, the one surface of the second lead board facing the one surface of the first lead board through a spacing;
a first terminal electrode formed on the one surface of the first lead board;
a second terminal electrode formed on the one surface of the second lead board; and
a solid electrolyte of conducting a lithium ion provided in the spacing between the one surface of the first lead board and the one surface of the second lead board so as to cover at least one of the first terminal electrode and the second terminal electrode.

2. The battery device as claimed in claim 1, wherein the first terminal electrode is cathode and the second terminal electrode is anode.

3. The battery device as claimed in claim 1, wherein a thickness of each of the first terminal electrode and the second terminal electrode is in the range of 50 to 500 μm.

4. The battery device as claimed in claim 1 further comprising one or more intermediate electrodes provided in the spacing so as to be parallel with both the first terminal electrode and the second terminal electrode wherein the first terminal electrode, the second terminal electrode and the one or more intermediate electrodes are connected in series or parallel.

5. The battery device as claimed in claim 1, wherein each of the first terminal electrode and the second terminal electrode includes a collector having a mesh structure with irregularities.

6. The battery device as claimed in claim 4, wherein each of the one or more intermediate electrodes includes at least a collector, wherein in the case where the first terminal electrode, the second terminal electrode and the one or more intermediate electrodes are connected in series, each collector is formed from a conductive substrate having a mesh structure.

7. The battery device as claimed in claim 1, wherein the solid electrolyte is constituted of a sulfide-based lithium-ion conductor.

8. The battery device as claimed in claim 7, wherein the sulfide-based lithium-ion conductor is an amorphous material, a crystalline material or a mixture of the amorphous material and the crystalline material.

9. An all-solid lithium-ion secondary battery provided with the battery device defined in the claim 1.
